(19) United States
(12) Patent Application Publication
(10) Pub. No.: US 2011/0040046 A1
(43) Pub. Date: Feb. 17, 2011

(54) ADDUCTS OF EPOXY RESINS AND PROCESS FOR PREPARING THE SAME

(76) Inventors: Robert E. Hefner, JR., Lake Jackson, TX (US); James W. Ringer, Midland, MI (US)

Correspondence Address: The Dow Chemical Company, P.O. BOX 1967, 2040 Dow Center, Midland, MI, 48641, US

(21) Appl. No.: 12/989,495

(22) PCT Filed: May 4, 2009
(86) PCT No.: PCT/US2009/042643

§ 371 Date: Oct. 25, 2010

Related U.S. Application Data
(60) Provisional application No. 61/055,232, filed on May 22, 2008.

(51) Int. Cl. C08G 59/24

(52) U.S. Cl. 525/533; 525/523

(57) ABSTRACT

An adduct comprises at least one reaction product of (i) an epoxy resin material (A) and (ii) a reactive compound (B). The epoxy resin material (A) comprises a cis, trans-1,3- and -1,4-cyclohexanedimethylether moiety and the reactive compound (B) comprises a compound having two or more reactive hydrogen atoms per molecule, wherein the reactive hydrogen atoms are reactive with epoxide groups. A curable epoxy resin composition comprises the adduct described above. A cured epoxy resin is prepared by a process of curing the curable epoxy resin composition.

### FIELD OF THE INVENTION

1. Field of the Invention

The present invention relates to adducts comprising a cis, trans-1,3- and -1,4-cyclohexanedimethylether moiety and a process for preparing the adducts.

2. Description of Background and Related Art

Conventional epoxy resin adducts and their preparation have been described in various references. For example, an adduct of diethylenetriamine and diglycidyl ether of bisphenol A is described by Henry Lee and Kris Neville in Handbook of Epoxy Resins published by McGraw Hill, Inc., New York, (1967) on pages 7-15 to 7-19. D.E.H.™ 52 (manufactured and marketed by The Dow Chemical Company) is a commercial adduct product of diethylenetriamine and diglycidyl ether of bisphenol A.

Daniel A. Scola in Developments in Reinforced Plastics 4 published by Elsevier Applied Science Publishers Ltd., England, pages 196-206 (1984) describes amine adducts of epoxy resins. The epoxy resin is selected from the diglycidyl ether of bisphenol A, tetraglycidyl 4,4′-diaminodiphenylmethane, triglycidyl p-aminophenol, epoxy phenol or cresol novalacs, hydrogenated diglycidyl ether of bisphenol A, or any combination thereof. The amine may be an aliphatic, cycloaliphatic, aromatic or alkylaromatic diamine.

J. Klee, et al. in Crosslinked Epoxies published by Walter de Gruyter and Co., Berlin, pages 47-54 (1987) describes the synthesis and analytical characterization of adducts of the diglycidyl ether of bisphenol A with primary monoamines including aniline, p-chloroaniline, benzylamine and cyclohexylamine.

However, there is no disclosure nor suggestion in the prior art that teaches an adduct formed by reacting an epoxy resin comprising a cis, trans-1,3- and -1,4-cyclohexanedimethylether moiety with a reactive compound comprising two or more reactive hydrogen atoms per molecule. There is no disclosure nor suggestion in the prior art that teaches a curable epoxy resin composition comprising the above adduct, or a cured epoxy resin prepared by curing the curable epoxy resin composition.

### SUMMARY OF THE INVENTION

The present invention uses epoxy resins comprising a cis, trans-1,3- and -1,4-cyclohexanedimethylether moiety to react with compounds comprising two or more reactive hydrogen atoms per molecule to produce adducts. The resultant adduct can be blended with one or more epoxy resins and, optionally, with a curing agent and/or a catalyst to form a curable epoxy resin composition. By curing the curable epoxy resin composition, a cured epoxy resin can be obtained.

One aspect of the present invention is directed to an adduct comprising at least one reaction product of (i) an epoxy resin material (A) and (ii) a reactive compound (B); wherein the epoxy resin material (A) comprises a cis, trans-1,3- and -1,4-cyclohexanedimethylether moiety; and wherein the reactive compound (B) comprises a compound having two or more reactive hydrogen atoms per molecule and the reactive hydrogen atoms are reactive with epoxide groups.

Another aspect of the present invention is directed to an adduct comprising at least one reaction product of (i) an epoxy resin material (A), (ii) a reactive compound (B), and (iii) a resin compound (C); wherein the epoxy resin material (A) comprises a cis, trans-1,3- and -1,4-cyclohexanedimethylether moiety; wherein the reactive compound (B) comprises a compound having two or more reactive hydrogen atoms per molecule and the reactive hydrogen atoms are reactive with epoxide groups; and wherein the resin compound (C) comprises one or more epoxy resins other than the epoxy resin material (A).

Another aspect of the present invention is directed to a process for preparing the above adducts.

Yet another aspect of the present invention is directed to a curable epoxy resin composition comprising (a) an adduct and (b) a resin compound (D); wherein the adduct comprises at least one reaction product of (i) an epoxy resin material (A) and (ii) a reactive compound (B), and optionally, a resin compound (C); wherein the epoxy resin material (A) comprises a cis, trans-1,3- and -1,4-cyclohexanedimethylether moiety; wherein the reactive compound (B) comprises a compound having two or more reactive hydrogen atoms per molecule and the reactive hydrogen atoms are reactive with epoxide groups; wherein optional resin compound (C) comprises one or more epoxy resins other than epoxy resin material (A); and wherein the resin compound (D) comprises one or more epoxy resins other than epoxy material (A) and other than epoxy resin compound (C).

Another aspect of the present invention is directed to a process of curing the above curable epoxy resin compositions.

A further aspect of the present invention is directed to a cured epoxy resin prepared by the above process of curing the curable epoxy resin compositions.

### DETAILED DESCRIPTION OF THE INVENTION

In the following detailed description, the specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the present invention is not limited to the specific embodiments described below, but rather; the invention includes all alternatives, modifications, and equivalents falling within the true scope of the appended claims.

Unless otherwise stated, a reference to a material, a compound, or a component includes the material, compound, or component by itself, as well as in combination with other materials, compounds, or components, such as mixtures or combinations of compounds.

As used herein, the singular forms “a,” “an,” and “the” include the plural reference unless the context clearly dictates otherwise.

As noted above, one aspect of the present invention is an adduct of the present invention comprises at least one reaction product of (i) an epoxy resin material (A) and (ii) a reactive compound (B); wherein the epoxy resin material (A) comprises a cis, trans-1,3- and -1,4-cyclohexanedimethylether moiety; and wherein the reactive compound (B) comprises a compound having two or more reactive hydrogen atoms per molecule, and the reactive hydrogen atoms are reactive with epoxide groups.

As used herein, the term “adduct” means a product of a direct addition of two or more distinct molecules, resulting in a single reaction product. The resultant reaction product or adduct is considered a distinct molecular species from the reactants.

As used herein, the term “cis, trans-1,3- and -1,4-cyclohexanedimethylether moiety” means a structure or a blend of chemical structures comprising four geometric isomers, a cis-1,3-cyclohexanedimethylether, a trans-1,3-cyclohexanedimethylether structure, a cis-1,4-cyclohexanedimethylether, and a trans-1,4-cyclohexanedimethylether, within an epoxy resin. The four geometric isomers are shown in the following structures:

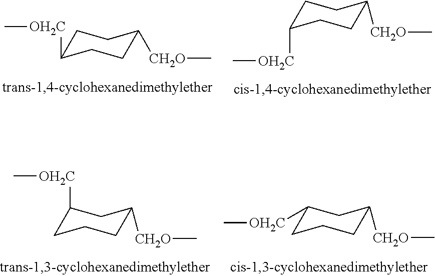

In general, the epoxy resin material (A) of the present invention is prepared by a process (e.g. an epoxidation reaction process) comprising reacting (a) a mixture of a cis-1,3-cyclohexanedimethanol, a trans-1,3-cyclohexanedimethanol, a cis-1,4-cyclohexanedimethanol, and a trans-1,4-cyclohexanedimethanol (also referred as the cis-1,3- and 1,4-cyclohexanedimethanol) with (b) an epihalohydrin, and (c) a basic acting substance. The process may optionally comprise, (d) a solvent and/or (e) a catalyst. The process may be, for example, a slurry epoxidation process, an anhydrous epoxidation process, or a Lewis acid catalyzed coupling and epoxidation process.

The mixture of the cis, trans-1,3- and 1,4-cyclohexanedimethanol used to prepare the epoxy resin material (A) of the present invention may comprise a controlled amount of the cis, trans-1,3-cyclohexanedimethanol, for example, from about 1 to about 99 percent, preferably from about 15 to about 85 percent, and more preferably from about 40 to about 60 percent by weight of the cis, trans-1,3-cyclohexanedimethanol based on the total weight of the mixture.

A detailed description of the epoxy resins comprising the cis, trans-1,3- and -1,4-cyclohexanedimethylether moiety and the processes for preparing the same is provided in co-pending U.S. patent application Ser. No. ______ (Attorney Docket No. 64833), incorporated herein by reference.

It has been discovered, as disclosed in a co-pending U.S. patent application Ser. No. ______ (Attorney Docket No. 64833) that epoxy resins comprising a cis, trans-1,3- and -1,4-cyclohexanedimethylether moiety have improved properties such as no crystallization at room temperature and lower viscosity compared to epoxy resins comprising a cis, trans-1,4-cyclohexanedimethanol alone. These improved properties increase the ability of the epoxy resins to accept higher solid contents. In addition, some epoxy resins comprising the cis, trans-1,3- and -1,4-cyclohexanedimethylether moiety as disclosed in the above co-pending patent application have very low chloride (including ionic, hydrolyzable and total chloride) content and high diglycidyl ether content, which provide the epoxy resins with increased reactivity toward conventional epoxy resin curing agents, reduced potential corrosivity, and improved electrical properties.

The epoxy resin material (A) of the present invention comprises a cis, trans-1,3- and -1,4-cyclohexanedimethylether moiety. Preferably, the epoxy resin material (A) comprises one of the following epoxy resins:
(1) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol (also referred to as diglycidyl ethers of cis, trans-1,3- and 1,4-cyclohexanedimethanol);
(2) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, and one or more oligomers thereof;
(3) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, and a monoglycidyl ether of trans-1,4-cyclohexanedimethanol; or
(4) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, a monoglycidyl ether of trans-1,4-cyclohexanedimethanol, and one or more oligomers thereof.

The epoxy resins (3) and (4) above may comprise a controlled amount of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol (also referred to as monodiglycidyl ethers of cis, trans-1,3- and 1,4-cyclohexanedimethanol). For example, the amount of the monoglycidyl ethers may be in the range of from about 0.1 percent to about 90 percent by weight; preferably, from about 0.1 percent to about 20 percent by weight; and more preferably, from about 0.1 percent to about 10 percent by weight based on the total weight of the epoxy resin material (A).

Various amounts of the mono and diglycidyl ethers of cis, trans-1,3-cyclohexanedimethanol relative to the oligomer may be present in the epoxy resin material (A) to influence both the properties of the epoxy resin material (A) as a reactant in the process to prepare the adduct of the present invention as well as the ultimate properties of the adduct product.

For example, if the epoxy resin material (A) has higher mono and diglycidyl ethers of cis, trans-1,3-cyclohexanedimethanol content and is substantially free of oligomer, the epoxy resin material (A) is generally in liquid form and has lower viscosity. The reactant comprising the epoxy resin material (A) generally favors the production of an adduct in liquid form and has lower viscosity or lower softening or melting point.

Various amounts of the individual geometrical isomers may also be present in the epoxy resin material (A) to influence both the properties of the epoxy resin material (A) as a reactant in the process to prepare the adduct as well as the ultimate properties of the adduct product.

For example, if the epoxy resin material (A) has a higher cis-isomer(s) content, the epoxy resin material (A) is generally in liquid form and has lower viscosity. The reactant comprising the epoxy resin material (A) generally favors the production of an adduct in liquid form and has lower viscosity or lower softening or melting point.

Various amounts of the monoglycidyl ethers of cis, trans-1,3-and -1,4-cyclohexanedimethanol relative to the diglycidyl ether of cis, trans-1,3-and 1,4-cyclohexanedimethanol may also be present in the epoxy resin material (A) to influence both the properties of the epoxy resin material (A) as a reactant in the process to prepare the adduct as well as the ultimate properties of the adduct product.

For example, if the epoxy resin material (A) has a higher monoglycidyl ether of cis, trans-1,3- and -1,4-cyclohexanedimethanol content, it generally favors the production of an adduct with lower functionality. The functionality of an adduct is referred to a number of reactive hydrogen atoms per molecule present in the adduct. The reactive hydrogen atom is the hydrogen atom that is reactive in a curing reaction with an epoxide group.

Other minor components may be present in the epoxy resin material (A). The amounts and types of the minor components may vary depending on the specific chemistry of the components present in the epoxy resin material (A) and the process used to prepare the epoxy resin material (A). In general, the epoxy resin material (A) may comprise from about 0.01 percent to less than about 10 percent, and preferably from 0.01 percent to about 5 percent of the minor components based on the total weight of the epoxy resin material (A). Examples of the minor components may include diglycidyl ether (2-epoxypropyl ether), chlorohydrin intermediate, and any combination thereof.

The reactive compound (B) used in the present invention to react with the epoxy resin material (A) to form the adduct comprises at least one compound having two or more reactive hydrogen atoms per molecule. The reactive hydrogen atoms are reactive with epoxide groups, such as those epoxide groups contained in the epoxy resin material (A).

The term “reactive hydrogen atom” as used herein means that the hydrogen atom is reactive with an epoxide group. The reactive hydrogen atom differs from other hydrogen atoms including those hydrogen atoms which are non-reactive with epoxide groups in the reaction of forming the adduct but may be reactive with epoxide groups in a later process of curing the adduct with one or more epoxy resins.

Hydrogen atoms can be non-reactive with the epoxide groups in the process of forming the adduct but reactive in a later process of curing the adduct with the epoxy resin, when there are other functional groups, which are much more reactive with the epoxide groups under reaction conditions used, present in the reaction of forming the adduct. For example, a reactive compound (B) may have two different functional groups each bearing at least one reactive hydrogen atom, with one functional group being inherently more reactive with an epoxide group than the other under the reaction conditions used. These reaction conditions may include the use of a catalyst which favors a reaction of the reactive hydrogen atom(s) of one functional group with an epoxide group over a reaction of the reactive hydrogen atom(s) of the other functional group with an epoxide group.

Other non-reactive hydrogen atoms may also include hydrogen atoms in the secondary hydroxyl groups which form during an epoxide ring opening reaction in the process of producing the adduct.

The reactive compound (B) comprising at least one compound having two or more reactive hydrogen atoms per molecule may further comprise aliphatic, cycloaliphatic or aromatic groups within the reactive compound (B) structure.

The aliphatic groups may be branched or unbranched. The aliphatic or cycloaliphatic groups may also be saturated or unsaturated and may comprise one or more substituents which are inert (not reactive) to the process of preparing the adduct of the present invention including the reactants and the products. The substituents may be attached to a terminal carbon atom or may be between two carbon atoms, depending on the chemical structures of the substituents. Examples of such inert substituents include halogen atoms, preferably chlorine or bromine, nitrile, nitro, alkyloxy, keto, ether (—O—), thioether (—S—), or tertiary amine. The aromatic ring, if present within the reactive compound (B) structure, may comprise one or more heteroatoms such as N, O, S and the like.

Examples of the reactive compound (B) may include compounds such as (a) di- and polyphenols, (b) di- and polycarboxylic acids, (c) di- and polymercaptans, (d) di- and polyamines, (e) primary monoamines, (f) sulfonamides, (g) aminophenols, (h) aminocarboxylic acids, (i) phenolic hydroxyl containing carboxylic acids, (j) sulfanilamides, and (k) any combination of any two or more of such compounds or the like.

Examples of the di- and polyphenols (a) include 1,2-dihydroxybenzene (catechol), 1,3-dihydroxybenzene (resorcinol), 1,4-dihydroxybenzene (hydroquinone), 4,4′-isopropylidenediphenol (bisphenol A), 4,4′-dihydroxydiphenylmethane, 3,3′,5,5′-tetrabromobisphenol A, 4,4′-thiodiphenol, 4,4′-sulfonyldiphenol, 2,2′-sulfonyldiphenol, 4,4′-dihydroxydiphenyl oxide, 4,4′-dihydroxybenzophenone, 1,1′-bis(4-hydroxyphenyl)-1-phenylethane, 3,3′,5,5′-tetrachlorobisphenol A, 3,3′-dimethoxybisphenol A, 3,3′,5,5′-tetramethyl-4,4′-dihydroxydiphenyl, 4,4′-dihydroxybiphenyl, 4,4′-dihydroxy-alpha-methylstilbene, 4,4′-dihydroxybenzanilide, 4,4′-dihydroxystilbene, 4,4′-dihydroxy-alpha-cyanostilbene, 1,1-bis(4-hydroxyphenyl)cyclohexane, 1,4-dihydroxy-3,6-dimethylbenzene, 1,4-dihydroxy-3,6-dimethoxybenzene, 1,4-dihydroxy-2-tert-butylbenzene, 1,4-dihydroxy-2-bromo-5-methylbenzene, 1,3-dihydroxy-4-nitrophenol, 1,3-dihydroxy-4-cyanophenol, tris(hydroxyphenyl)methane, dicyclopentadiene or an oligomer thereof and phenol or substituted phenol condensation products, and any mixture thereof.

Examples of the di- and polycarboxylic acids (b) include 4,4′-dicarboxydiphenylmethane, terephthalic acid, isophthalic acid, 1,4-cyclohexanedicarboxylic acid, 1,6-hexanedicarboxylic acid, 1,4-butanedicarboxylic acid, dicyclopentadienedicarboxylic acid, tris(carboxyphenyl)methane, 1,1-bis(4-carboxyphenyl)cyclohexane, 3,3′,5,5′-tetramethyl-4,4′-dicarboxydiphenyl, 4,4′-dicarboxy-alpha-methylstilbene, 1,4-bis(4-carboxyphenyl)-trans-cyclohexane, 1,1′-bis(4-carboxyphenyl)cyclohexane, 1,3-dicarboxy-4-methylbenzene, 1,3-dicarboxy-4-methoxybenzene, 1,3-dicarboxy-4-bromobenzene, and any combination thereof.

Examples of the di- and polymercaptans (c) include 1,3-benzenedithiol, 1,4-benzenedithiol, 4,4′-dimercaptodiphenylmethane, 4,4′-dimercaptodiphenyl oxide, 4,4′-dimercapto-alpha-methylstilbene, 3,3′,5,5′-tetramethyl-4,4′-dimercaptodiphenyl, 1,4-cyclohexanedithiol, 1,6-hexanedithiol, 2,2′-dimercaptodiethylether, 1,2-dimercaptopropane, bis(2-mercaptoethyl)sulfide, tris(mercaptophenyl)methane, 1,1-bis(4-mercaptophenyl)cyclohexane, and any combination thereof.

Examples of the di- and polyamines (d) include 1,2-diaminobenzene, 1,3-diaminobenzene, 1,4-diaminobenzene, 4,4′-diaminodiphenylmethane, 4,4′-diaminodiphenylsulfone, 2,2′-diaminodiphenylsulfone, 4,4′-diaminodiphenyl oxide, 3,3′,5,5′-tetramethyl-4,4′-diaminodiphenyl, 3,3′-dimethyl-4,4′-diaminodiphenyl, 4,4′-diamino-alpha-methylstilbene, 4,4′-diaminobenzanilide, 4,4′-diaminostilbene, 1,4-bis(4-aminophenyl)-trans-cyclohexane, 1,1-bis(4-aminophenyl)cyclohexane, tris(aminophenyl)methane, 1,4-cyclohexanediamine, 1,6-hexanediamine, piperazine, ethylenediamine, diethyletriamine, triethylenetetramine, tetraethylenepentamine, 1-(2-aminoethyl)piperazine, bis(aminopropyl)ether, bis(aminopropyl)sulfide, bis(aminomethyl)norbornane, 2,2′-bis(4-aminocyclohexyl)propane, and any combination thereof.

Examples of the primary monoamines (e) include aniline, 4-chloroaniline, 4-methylaniline, 4-methoxyaniline, 4-cyanoaniline, 2,6-dimethylaniline, 4-aminodiphenyl oxide, 4-aminodiphenylmethane, 4-aminodiphenylsulfide, 4-aminobenzophenone, 4-aminodiphenyl, 4-amino stilbene, 4-amino-alpha-methylstilbene, methylamine, 4-amino-4′-nitrostilbene, n-hexylamine, cyclohexylamine, aminonorbornane, and any combination thereof.

The primary monoamines represent a special class of the reactive compound (B) of the present invention. According to the present invention, the reaction of the primary monoamine with the epoxy resin material (A), for example, the diglycidyl ethers of cis and trans -1,3- and 1,4-cyclohexanedimethanol, produces an adduct which is substantially difunctional (i.e. the adduct has a functionality of about 2) with respect to the reactive hydrogen atom(s) (e.g. the amine hydrogen atom when the primary monoamine is used as the reactive compound(B)) present in the adduct. This difunctional adduct can be used as a linear chain extender for curing epoxy resins. The difunctional adduct provides a linear chain extension to the epoxy resin structure instead of cros slinking the epoxy resin structure. Other classes of reactive compound (B), such as secondary diamines, may also be used to form a difunctional adduct which can be used as a linear chain extender for curing an epoxy resin.

As a general illustration of a preferred embodiment of the present invention, an epoxy resin (E-resin) may be reacted with a difunctional adduct (adduct A1) which comprises a compound having two reactive hydrogen atoms per molecule. The adduct A1 provides linear chain extension to the E-resin structure. The linear chain extension function provided by the adduct A1 can be used to impart toughness to the cured E-resin. In addition, the adduct A1 may also be crosslinked with another adduct (adduct A2) which is different from the adduct A1, a curing agent, or any mixture thereof. The adduct A1 which provides the linear chain extension may be separately reacted with the E-resin before crosslinking with the adduct A2, the curing agent, or the mixture thereof. Alternately, the adduct A1 which provides the linear chain extension may be added together with the adduct A2, the curing agent, or the mixture thereof to the E-resin to give simultaneous linear chain extension and cros slinking of the E-resin structure.

For example, a secondary diamine adduct prepared from diglycidyl ethers of cis, trans-1,3- and 1,4-cyclohexanedimethanol and a primary monoamine is reacted with an E-resin to give linear chain extension to the E-resin. The remaining epoxide groups in the E-resin may be reacted with a curing agent having more than two reactive hydrogen atoms per molecule, e.g. a polyalkylenepolyamine, to induce crosslinking of the E-resin. The linear chain extension and the crosslinking of the E-resin may be performed separately or simultaneously.

When monoglycidyl ethers of cis, trans-1,3- and 1,4-cyclohexanedimethanol are present with the diglycidyl ethers of cis, trans-1,3- and 1,4-cyclohexanedimethanol as the epoxy resin material (A) in forming the adduct of the present invention, the adduct formed may be substantially monofunctional with respect to the reactive hydrogen atom(s) present in the adduct and thus the monoglycidyl ethers function as a chain terminator in curing an epoxy resin or in a linear chain extension process. Monofunctionality especially results when the monoglycidyl ethers are reacted with a primary monoamine or a secondary diamine.

Ammonia represents another special class of reactive compound (B) of the present invention. The ammonia may be used in the form of liquified ammonia (NH₃) or ammonium hydroxide (NH₄OH).

Examples of the sulfonamides (f) include phenylsulfonamide, 4-methoxyphenylsulfonamide, 4-chlorophenylsulfonamide, 4-bromophenylsulfonamide, 4-methylsulfonamide, 4-cyanosulfonamide, 2,6-dimethyphenylsulfonamide, 4-sulfonamidodiphenyl oxide, 4-sulfonamidodiphenylmethane, 4-sulfonamidobenzophenone, 4-sulfonylamidodiphenyl, 4-sulfonamidostilbene, 4-sulfonamido-alpha-methylstilbene, and any combination thereof.

Examples of the aminophenols (g) include o-aminophenol, m-aminophenol, p-aminophenol, 2-methoxy-4-hydroxyaniline, 3,5-dimethyl-4-hydroxyaniline, 3-cyclohexyl-4-hydroxyaniline, 2,6-dibromo-4-hydroxyaniline, 5-butyl-4-hydroxyaniline, 3-phenyl-4-hydroxyaniline, 4-(1-(3-aminophenyl)-1-methylethyl)phenol, 4-(1-(4-aminophenyl)ethyl)phenol, 4-(4-aminophenoxy)phenol, 4-((4-aminophenyl)thio)phenol, (4-aminophenyl)(4-hydroxyphenyl)methanone, 4-((4-aminophenyl) sulfonyl)phenol, 4-(1-(4-amino-3,5-dibromophenyl)-1-methylethyl)-2,6-dibromophenol, N-methyl-p-aminophenol, 4-amino-4′-hydroxy-alpha-methylstilbene, 4-hydroxy-4′-amino-alpha-methylstilbene, and any combination thereof.

Examples of the aminocarboxylic acids (h) include 2-aminobenzoic acid, 3-aminobenzoic acid, 4-aminobenzoic acid, 2-methoxy-4-aminobenzoic acid, 3,5-dimethyl-4-aminobenzoic acid, 3-cyclohexyl-4-aminobenzoic acid, 2,6-dibromo-4-aminobenzoic acid, 5-butyl-4-aminobenzoic acid, 3-phenyl-4-aminobenzoic acid, 4-(1-(3-aminophenyl)-1-methylethyl)benzoic acid, 4-(1-(4-aminophenyl)ethyl)benzoic acid, 4-(4-aminophenoxy)benzoic acid, 4-((4-aminophenyl)thio)benzoic acid, (4-aminophenyl)(4-carboxyphenyl)methanone, 4-((4-aminophenyl)sulfonyl)benzoic acid, 4-(1-(4-amino-3,5-dibromophenyl)-1-methylethyl)-2,6-dibromobenzoic acid, N-methyl-4-aminobenzoic acid, 4-amino-4′-carboxy-alpha-methylstilbene, 4-carboxy-4′-amino-alpha-methylstilbene, glycine, N-methylglycine, 4-aminocyclohexanecarboxylic acid, 4-aminohexanoic acid, 4-piperidinecarboxylic acid, 5-aminophthalic acid, and any combination thereof.

Examples of the carboxylic acids (i) include 2-hydroxybenzoic acid, 3-hydroxybenzoic acid, 4-hydroxybenzoic acid, 2-methoxy-4-hydroxybenzoic acid, 3,5-dimethyl-4-hydroxybenzoic acid, 3-cyclohexyl-4-hydroxybenzoic acid, 2,6-dibromo-4-hydroxybenzoic acid, 5-butyl-4-hydroxybenzoic acid, 3-phenyl-4-hydroxybenzoic acid, 4-(1-(3-hydroxyphenyl)-1-methylethyl)benzoic acid, 4-(1-(4-hydroxyphenyl)ethyl)benzoic acid, 4-(4-hydroxyphenoxy)benzoic acid, 4-((4-hydroxyphenyl)thio)benzoic acid, (4-hydroxyphenyl)(4-carboxyphenyl)methanone, 4-((4-hydroxyphenyl)sulfonyl)benzoic acid, 4-(1-(4-hydroxy-3,5-dibromophenyl)-1-methylethyl)-2,6-dibromobenzoic acid, 4-hydroxy-4′-carboxy-alpha-methylstilbene, 4-carboxy-4′-hydroxy-alpha-methylstilbene, 2-hydroxyphenylacetic acid, 3-hydroxyphenylacetic acid, 4-hydroxyphenylacetic acid, 4-hydroxyphenyl-2-cyclohexanecarboxylic acid, 4-hydroxyphenoxy-2-propanoic acid, and any combination thereof.

Examples of the sulfanilamides (j) include o-sulfanilamide, m-sulfanilamide, p-sulfanilamide, 2-methoxy-4-aminobenzoic acid, 2,6-dimethyl-4-sulfonamido-1-aminobenzene, 3-methyl-4-sulfonamido-1-aminobenzene, 5-methyl-3-sulfonamido-1-aminobenzene, 3-phenyl-4-sulfonamido-1-aminobenzene, 4-(1-(3-sulfonamidophenyl)-1-methylethyl)aniline, 4-(1-(4-sulfonamidophenyl)ethyl)aniline, 4-(4-sulfonamidophenoxy)aniline, 4-((4-sulfonamidophenyl)thio)aniline, (4-sulfonamidophenyl)(4-aminophenyl)methanone, 4-((4-sulfonamidophenyl)sulfonyl)aniline, 4-(1-(4-sulfonamido-3,5-dibromophenyl)-1-methylethyl)-2,6-dibromoaniline, 4-sulfonamido-1-N-methylaminobenzene, 4-amino-4′-sulfonamido-alpha-methylstilbene, 4-sulfonamido-4′-amino-alpha-methylstilbene, and any combination thereof.

In another aspect of the present invention, the adduct of the present invention may comprise at least one reaction product of (i) the epoxy resin material (A) described above, (ii) the reactive compound (B) described above, and (iii) a resin compound (C); wherein the resin compound (C) comprises one or more epoxy resins other than the epoxy resin material (A).

The epoxy resin which can be used as the resin compound (C) other than the epoxy resin material (A) may be any epoxide-containing compound which has an average of more than one epoxide group per molecule. The epoxide group can be attached to any oxygen, sulfur or nitrogen atom or the single bonded oxygen atom attached to the carbon atom of a —CO—O— group. The oxygen, sulfur, nitrogen atom, or the carbon atom of the

—CO—O— group may be attached to an aliphatic, cycloaliphatic, polycycloaliphatic or aromatic hydrocarbon group. The aliphatic, cycloaliphatic, polycycloaliphatic or aromatic hydrocarbon group can be substituted with any inert substituents including, but not limited to, halogen atoms, preferably fluorine, bromine or chlorine; nitro groups; or the groups can be attached to the terminal carbon atoms of a compound containing an average of more than one —(O—CHR^{a}—CHR^{a})ₜ— group, wherein each R^{a} is independently a hydrogen atom or an alkyl or haloalkyl group containing from one to two carbon atoms, with the proviso that only one R^{a} group can be a haloalkyl group, and t has a value from one to about 100, preferably from one to about 20, more preferably from one to about 10, and most preferably from one to about 5.

More specific examples of the epoxy resin which can be used as the resin compound (C) include diglycidyl ethers of 1,2-dihydroxybenzene (catechol); 1,3-dihydroxybenzene (resorcinol), 1,4-dihydroxybenzene (hydroquinone), 4,4′-isopropylidenediphenol (bisphenol A), 4,4′-dihydroxydiphenylmethane, 3,3′,5,5′-tetrabromobisphenol A, 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1′-bis(4-hydroxyphenyl)-1-phenylethane; 3,3′-5,5′-tetrachlorobisphenol A; 3,3′-dimethoxybisphenol A; 4,4′-dihydroxybiphenyl; 4,4′-dihydroxy-alpha-methylstilbene; 4,4′-dihydroxybenzanilide; 4,4′-dihydroxystilbene; 4,4′-dihydroxy-alpha-cyanostilbene; N,N′-bis(4-hydroxyphenyl)terephthalamide; 4,4′-dihydroxyazobenzene; 4,4′-dihydroxy-2,2′-dimethylazoxybenzene; 4,4′-dihydroxydiphenylacetylene; 4,4′-dihydroxychalcone; 4-hydroxyphenyl-4-hydroxybenzoate; dipropylene glycol, poly(propylene glycol), thiodiglycol; the triglycidyl ether of tris(hydroxyphenyl)methane; the polyglycidyl ethers of a phenol or alkyl or halogen substituted phenol-aldehyde acid catalyzed condensation product (novolac resins); the tetraglycidyl amines of 4,4′-diaminodiphenylmethane; 4,4′-diaminostilbene; N,N′-dimethyl-4,4′-diaminostilbene; 4,4′-diaminobenzanilide; 4,4′-diaminobiphenyl; the polyglycidyl ether of the condensation product of a dicyclopentadiene or an oligomer thereof and a phenol or alkyl or halogen substituted phenol; and any combination thereof.

The epoxy resin which can be used as the resin compound (C) may also include an advanced epoxy resin product. The advanced epoxy resin may be a product of an advancement reaction of an epoxy resin with an aromatic di- and polyhydroxyl, or carboxylic acid containing compound. The epoxy resin used in the advancement reaction may include any one or more of the aforesaid epoxy resins suitable for the resin compound (B) comprising the di- or polyglycidyl ethers.

Examples of the aromatic di- and polyhydroxyl or carboxylic acid containing compound include hydroquinone, resorcinol, catechol, 2,4-dimethylresorcinol; 4-chlororesorcinol; tetramethylhydroquinone; bisphenol A; 4,4′-dihydroxydiphenyimethane; 4,4′-thiodiphenol; 4,4′-sulfonyldiphenol; 2,2′-sulfonyldiphenol; 4,4′-dihydroxydiphenyl oxide; 4,4′-dihydroxybenzophenone; 1,1-bis(4-hydroxyphenyl)-1-phenylethane; 4,4′-bis (4(4-hydroxyphenoxy)-phenylsulfone)diphenyl ether; 4,4′-dihydroxydiphenyl disulfide; 3,3′,3,5′-tetrachloro-4,4′-isopropylidenediphenol; 3,3′,3,5′-tetrabromo-4,4′-isopropylidenediphenol; 3,3′-dimethoxy-4,4′-isopropylidenediphenol; 4,4′-dihydroxybiphenyl; 4,4′-dihydroxy-alpha-methylstilbene; 4,4′-dihydroxybenzanilide; bis(4-hydroxyphenyl)terephthalate; N,N′-bis(4-hydroxyphenyl)terephthalamide; bis(4′-hydroxybiphenyl)terephthalate; 4,4′-dihydroxyphenylbenzoate; bis(4′-hydroxyphenyl)-1,4-benzenediimine; 1,1′-bis(4-hydroxyphenyl)cyclohexane; phloroglucinol; pyrogallol; 2,2′,5,5′-tetrahydroxydiphenylsulfone; tris(hydroxyphenyl)methane; dicyclopentadiene diphenol; tricyclopentadienediphenol; terephthalic acid; isophthalic acid; 4,4′-benzanilidedicarboxylic acid; 4,4′-phenylbenzoatedicarboxylic acid; 4,4′-stilbenedicarboxylic acid; adipic acid; and any combination thereof.

Preparation of the aforementioned advanced epoxy resin products can be performed using known methods, for example, an advancement reaction of an epoxy resin with one or more suitable compounds having an average of more than one reactive hydrogen atom per molecule, wherein the reactive hydrogen atom is reactive with an epoxide group in the epoxy resin.

The ratio of the compound having an average of more than one reactive hydrogen atom per molecule to the epoxy resin is generally from about 0.01:1 to about 0.95:1, preferably from about 0.05:1 to about 0.8:1, and more preferably from about 0.10:1 to about 0.5:1 equivalents of the reactive hydrogen atom per equivalent of the epoxide group in the epoxy resin.

In addition to the aforementioned dihydroxyaromatic and dicarboxylic acid compounds, examples of the compound having an average of more than one reactive hydrogen atom per molecule may also include dithiol, disulfonamide or compounds containing one primary amine or amide group, two secondary amine groups, one secondary amine group and one phenolic hydroxy group, one secondary amine group and one carboxylic acid group, or one phenolic hydroxy group and one carboxylic acid group, and any combination thereof.

The advancement reaction may be conducted in the presence or absence of a solvent with the application of heat and mixing. The advancement reaction may be conducted at atmospheric, superatmospheric or subatmospheric pressures and at temperatures of from about 20° C. to about 260° C., preferably, from about 80° C. to about 240° C., and more preferably from about 100° C. to about 200° C.

The time required to complete the advancement reaction depends upon the factors such as the temperature employed, the chemical structure of the compound having more than one reactive hydrogen atom per molecule employed, and the chemical structure of the epoxy resin employed. Higher temperature may require shorter reaction time whereas lower temperature requires a longer period of reaction time.

In general, the time for completion of the advancement reaction may ranged from about 5 minutes to about 24 hours, preferably from about 30 minutes to about 8 hours, and more preferably from about 30 minutes to about 4 hours.

A catalyst may also be added in the advancement reaction. Examples of the catalyst may include phosphines, quaternary ammonium compounds, phosphonium compounds and tertiary amines. The catalyst may be employed in quantities of from about 0.01 percent to about 3 percent, preferably from about 0.03 percent to about 1.5 percent, and more preferably from about 0.05 percent to about 1.5 percent by weight based upon the total weight of the epoxy resin.

Other details concerning an advancement reaction useful in preparing the advanced epoxy resin product for the resin compound (B) of the present invention are provided in U.S. Pat. No. 5,736,620 and in Handbook of Epoxy Resins by Henry Lee and Kris Neville, incorporated herein by reference.

The adduct of the present invention is a reaction product of the epoxy resin material (A), the reactive compound (B) and, optionally, the resin compound (C).

According to the present invention, a sufficient amount of the epoxy resin material (A) and the resin compound (C), if used, and an excess amount of the reactive compound (B) are provided in a reaction mixture to form the adduct of the present invention. At the end of the reaction for forming the adduct of the present invention (also referred as “the adduct reaction”), essentially all of the epoxide groups in the epoxy resin material (A) are reacted with the reactive hydrogen atoms in the reactive compound (B). The unreacted reactive compound (B) may be removed at the end of the reaction or may remain as a part of the adduct product.

In general, the ratio of the reactive compound (B) and the epoxy resin material (A) is from about 2:1 to about 100:1, preferably from about 3:1 to about 60:1, and more preferably from about 4:1 to about 40:1 equivalents of the reactive hydrogen atom in the reactive compound (B) per equivalent of epoxide group in the epoxy resin material (A) and resin compound (C), if used.

A catalyst may be employed to prepare the adduct of the present invention. Examples of the catalyst include phosphines, quaternary ammonium compounds, phosphonium compounds, tertiary amines, and any mixture thereof.

The amount of catalyst used, if any, depends upon the particular reactants used for preparing the adduct and the type of catalyst employed. In general, the catalyst may be used in an amount of from about 0.01 to about 1.5 percent, and preferably from about 0.03 to about 0.75 percent by weight based on the total weight of the adduct.

One or more solvents may be present in the adduct reaction of the present invention. The presence of a solvent or solvents can improve the solubility of the reactants or, if the reactant is in a solid form, dissolve the solid reactant for easy mixing with other reactants. The presence of the solvent may also dilute the concentration of the reactants in order to moderate the adduct forming reaction such as to control heat generated from the adduct forming reaction or to lower the effective concentration of a reactant which can in turn influence the structure of the adduct product, for example, produce an adduct with less oligomeric component.

The solvent may be any solvent which is substantially inert to the adduct reaction including inert to the reactants, the intermediate products if any, and the final products. Examples of the suitable solvents useful in the present invention include aliphatic, cycloaliphatic and aromatic hydrocarbons, halogenated aliphatic and cycloaliphatic hydrocarbons, aliphatic and cycloaliphatic secondary alcohols, aliphatic ethers, aliphatic nitriles, cyclic ethers, glycol ethers, esters, ketones, amides, sulfoxides, and any combination thereof.

Preferred examples of the solvents include pentane, hexane, octane, cyclohexane, methylcyclohexane, toluene, xylene, methylethylketone, methylisobutylketone, cyclohexanone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, N,N-dimethylacetamide, acetonitrile, isopropanol, and any combination thereof.

The solvent may be removed at the completion of the adduct reaction using conventional means, such as, for example, vacuum distillation. Alternatively, the solvent may also be left in the adduct product to provide a solvent borne adduct which may be used later, for example, in the preparation of coating or film.

The adduct forming reaction conditions may vary depending upon factors such as types and amounts of reactants employed, type and amount of catalyst used, if any, type and amount of solvent used, if any, and modes of addition of the reactants employed.

For example, the adduct reaction may be conducted at atmospheric (e.g. 760 mm Hg), superatmospheric or subatmospheric pressures and at temperature of from about 0° C. to about 260° C., and preferably from about 20° C. to about 200° C., and more preferably from about 35° C. to about 160° C.

The time required to complete the adduct reaction depends not only upon the aforementioned factors, but also upon the temperature employed. Higher temperature requires a shorter period of time, whereas lower temperature requires a longer period of time. In general, the time to complete the adduct reaction is preferred to be from about 5 minutes to about one week, more preferably from about 30 minutes to about 72 hours, and most preferably from about 60 minutes to 48 hours.

The time and temperature of the adduct reaction may have significant impact on the distribution of components in the formation of the adduct of the present invention. For example, with higher reaction temperature, longer reaction time, and when the reactive compound (B) comprises a material having only two reactive hydrogen atoms per molecule, the adduct reaction favors the formation of the adduct with more oligomeric components. The adduct reaction favors the formation of the adduct with more branched or crosslinked components when the reactive compound (B) comprises a material having more than two reactive hydrogen atoms per molecule.

In carrying out the adduct forming reaction, the epoxy resin material (A) may be directly mixed together with the reactive compound (B), added to the reactive compound (B) in incremental steps, or added to the reactive compound (B) continuously. In addition, one or more solvents may be first added to the epoxy resin material (A) and/or the reactive compound (B) before mixing the epoxy resin material (A) and the reactive compound (B).

If incremental addition of the epoxy resin material (A) is used, all or a part of an added increment may be allowed to react prior to addition of the next increment. The incremental addition of the epoxy resin material (A) reacted within an excess amount of the reactive compound (B) generally favors the formation of the adduct with a lesser amount or free of oligomeric components.

Various post treatments may be applied to the process of preparing the adduct of the present invention in order to modify: 1) the distribution of components of the adduct (e.g. distribution of the amount of the components present in the adduct formed from the mono, diglycidyl ethers of cis, trans-1,3- and 1,4-cyclohexanedimethanol, and one or more oligomers thereof), 2) the reactivity of the adduct, and/or 3) the physical properties of the adduct.

For example, for an adduct prepared from a reaction between the diglycidyl ethers of cis, trans-1,3- and 1,4-cyclohexanedimethanol (as the epoxy resin material (A)) and cyclohexylamine (as the reactive compound (B)), when a large stoichiometric excess amount of the primary amine groups derived from the cyclohexylamine reacts with the epoxide groups derived from the diglycidyl ethers of cis, trans-1,3- and 1,4-cyclohexanedimethanol, the reaction may lead to the formation of an adduct with a low content of oligomeric component. The resultant adduct product may also comprise, as a part of the adduct product, a high concentration of cyclohexylamine as the unreacted reactive compound (B). Accordingly, post treatment of the adduct product, such as vacuum distillation, may be employed to strip out the unreacted reactive compound (B).

Other post treatment methods used to modify the distribution of the adduct components may also be employed, such as, for example, recrystallization, chromatographic separation, extraction, zone refining, crystal refining, falling film distillation, wiped film distillation, simple distillation, preferential chemical derivatization and removal of one or more components of the adduct, and any combination thereof.

According to the present invention, the reaction of the epoxy resin material (A) and the reactive compound (B) to form the adduct of the present invention involves a ring opening reaction. During the ring opening reaction, the epoxide groups in the epoxy resin material (A) reacts with the reactive hydrogen atoms in the reactive compound (B) to give characteristic 2-hydroxylpropyl functionalities as linkages between residual structures of the epoxy resin material (A) and residual structures of the reactive compound (B).

An example of the adduct of the present invention is a reaction product of diglycidyl ethers of cis, trans-1,3- and 1,4-cyclohexanedimethanol (as the epoxy resin material (A)) and cyclohexylamine (as the reactive compound (B)). The following adduct structure shows the 2-hydroxylpropyl functionality as the linkage between the residual structure of the epoxy resin material (A) and the residual structure of the reactive compound (B) (geometrical isomers and substitution are not shown):

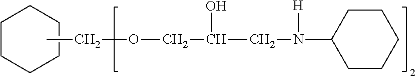

The reactive compound (B) may be the compounds having dual functional groups, such as (f) sulfonamides, (g) aminophenols, (h) aminocarboxylic acids, (i) phenolic hydroxyl containing carboxylic acids, and (j) sulfanilamides. These compounds may be utilized to provide an adduct with different functional groups of different reactivity for curing an epoxy resin. An example of this type of adduct is a reaction product of an aminophenol compound, p-N-methylaminomethylphenol (as the reactive compound (B)), and the diglycidyl ethers of cis, trans-1,3- and 1,4-cyclohexanedimethanol (as the epoxy resin material (A)). The reaction provides the adduct with phenolic hydroxyl terminated groups when the reaction is under mild conditions including (a) with no catalyst, (b) at low temperature (e.g. about 25° C. to about 50° C.), (c) for a relatively long reaction time, (d) using incremental or slow continuous addition of the epoxy resin material (A) to a large stoichiometric excess of the reactive compound (B), and (e) both the epoxy resin material (A) and the reactive compound (B) are in solvent. The following adduct structure shows the adduct comprising phenolic hydroxyl terminated groups (geometrical isomers and substitution are not shown):

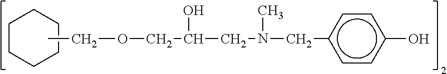

A catalysis reaction favoring one functional group over another with the epoxide group may also be employed. For example, when a reactive compound (B) comprising at least two different functional groups each bearing at least one reactive hydrogen atom is used to form the adduct of the present invention, a catalyst which favors a reaction of reactive hydrogen atom(s) of one type of functional group with an epoxide group over a reaction of reactive hydrogen atom(s) of the other type of functional group with an epoxide group may be employed.

The adduct may also comprise at least one oligomeric component derived from a reaction of epoxide groups from at least two separate epoxy resin molecules with each respective epoxy resin having one of the epoxide groups already reacted with the reactive hydrogen atoms in the reactive compound (B).

An example of this type of adduct is a reaction product of diglycidyl ethers of cis, trans-1,3- and 1,4-cyclohexanedimethanol and cyclohexylamine. The following adduct structure shows that the oligomeric component is derived from at least two epoxide groups from two separate diglycidyl ethers of cis, trans-1,3- and 1,4-cyclohexanedimethanol each with one of the epoxide groups already reacted with cyclohexylamine (geometrical isomers and substitution are not shown), wherein n has a value of one or more:

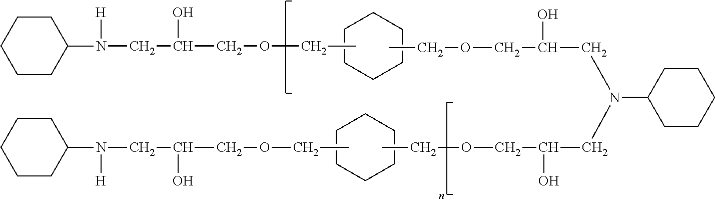

The adduct may also comprise at least one branched or crosslinked adduct structure derived from any one of the following reactions:
(1) a reaction between an epoxide group from an epoxy resin which has already been adducted at another epoxide group of the epoxy resin and a hydroxyl group of a 2-hydroxypropyl linkage from an adduct of the present invention; or
(2) a reaction between three separate epoxy resin molecules with three reactive hydrogen atoms from the reactive compound (B) of the present invention.

An example of the above reaction (1) is a reaction of a hydroxyl group from an adduct of the diglycidyl ether of cis, trans-1,3- and 1,4-cyclohexanedimethanol and cyclohexylamine with an epoxide group from a second diglycidyl ether of cis, trans-1,3- and 1,4-cyclohexanedimethanol which has already been adducted with cyclohexylamine at one of the epoxide groups. The chemical structure of the resultant reaction product is shown as follows (geometrical isomers and substitution are not shown):

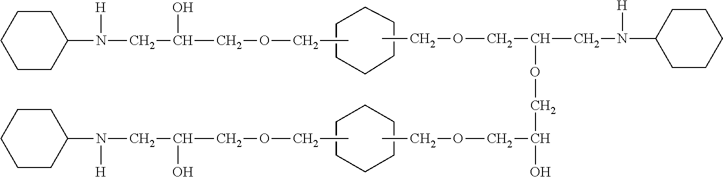

An example of the above reaction (2) is a reaction of an amino hydrogen of the adduct of diethylenetriamine and the diglycidyl ether of cis, trans-1,3- and 1,4-cyclohexanedimethanol wherein an epoxide group from a second diglycidyl ether of cis, trans-1,3- and 1,4-cyclohexanedimethanol which has already reacted with another amino hydrogen in the diethylenetriamine moiety. The chemical structure of the resultant reaction product is shown as follows (only one end of each of the diglycidyl ether molecules is shown, geometrical isomers and substitution are not shown):

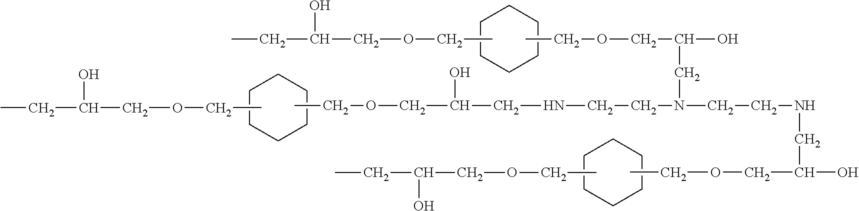

In addition, some minor structures may be present in the adduct of the present invention, for example, 1,2-glycol groups derived from a hydrolysis of an epoxide group in the epoxy resin material (A), or halomethyl groups derived from an addition of epihalohydrin to a hydroxyl group of an intermediate halohydrin molecule during the process of forming the epoxy resin material (A).

Other minor structures may be formed via a reaction of a backbone hydroxyl group in the adduct of the diglycidyl ether of cis, trans-1,3- and 1,4-cyclohexanedimethanol. For example, a reaction of the secondary hydroxyl group with a carboxylic acid group present in certain of the reactive compound (B), results in the formation of a backbone ester linkage in the adduct.

The curable epoxy resin composition of the present invention comprises (a) an adduct and (b) a resin compound (D); wherein the adduct is the adduct of the present invention, which, as described above, comprises (ii) at least one reaction product of the epoxy resin material (A), (ii) the reactive compound (B), and optionally, (iii) the resin compound (C). The compound (D), also as described above, comprises one or more epoxy resins. The curable epoxy resin composition, when cured, provides a cured epoxy resin comprising the cis, trans-1,3- and 1,4-cyclohexanedimethylether moiety.

The term “curable” (also referred to as “thermosettable”) means that the composition is capable of being subjected to conditions which will render the composition to a cured or thermoset state or condition.

The term “cured” or “thermoset” is defined by L. R. Whittington in Whittington's Dictionary of Plastics (1968) on page 239 as follows: “Resin or plastics compounds which in their final state as finished articles are substantially infusible and insoluble. Thermosetting resins are often liquid at some stage in their manufacture or processing, which are cured by heat, catalysis, or some other chemical means. After being fully cured, thermosets cannot be resoftened by heat. Some plastics which are normally thermoplastic can be made thermosetting by means of crosslinking with other materials.”

The curable epoxy resin composition of the present invention is prepared by mixing the adduct of the present invention with the resin compound (D) in amounts which will effectively cure the curable epoxy resin composition, with the understanding that the amounts will depend upon the specific adduct and the resin compound (D) employed.

The epoxy resin which can be used as the resin compound (D) for the curable epoxy resin composition of the present invention may be any epoxide-containing compound which has an average of more than one epoxide group per molecule. Examples of the epoxy resin include those epoxy resins which are suitable for the resin compound (C) and the epoxy resin material (A) described above.

Generally, the ratio of the adduct of the present invention and the resin compound (D) is from about 0.60:1 to about 1.50:1, and preferably from about 0.95:1 to about 1.05:1 equivalents of reactive hydrogen atom present in the adduct per equivalent of epoxide group in the resin compound (D) at the conditions employed for curing.

A preferred curable epoxy resin composition of the present invention comprises the adduct of the present invention and the resin compound (D), wherein the resin compound (D) comprises one or more of epoxy resins, which include those epoxy resins that are suitable for the epoxy resin material (A) described above, for example, the resin compound (D) may comprise one or more epoxy resins comprising a cis, trans-1,3- and 1,4-cyclohexanedimethylether moiety.

Another preferred curable epoxy resin composition of the present invention comprises (i) the adduct of the present invention and (ii) the resin compound (D), wherein the resin compound (D) comprises one or more of epoxy resins, and the adduct comprises at least one reaction product of an epoxy resin material (A) and a reactive compound (B). The reactive compound (B), for example, comprises an aliphatic or cycloaliphatic diamine, an aliphatic or cycloaliphatic polyamine, an aliphatic or cycloaliphatic dicarboxylic acid, or an aliphatic or cycloaliphatic aminocarboxylic acid, a diaminocarboxylic acid, an aminodicarboxylic acid, or a diaminodicarboxylic acid, or any combination thereof. The curable epoxy resin composition, when cured, provides a cured epoxy resin free of any aromatic group.

The process of curing the curable epoxy resin composition of the present invention may be conducted at atmospheric (e.g. 760 mm Hg), superatmospheric or subatmospheric pressures and at a temperature from about 0° C. to about 300° C., preferably from about 25° C. to about 250° C., and more preferably from about 50° C. to about 200° C.

The time required to complete the curing may depend upon the temperature employed. Higher temperatures generally require a shorter period of time whereas lower temperatures generally require longer periods of time. In general, the required time for completion of the curing is from about 1 minute to about 48 hours, preferably from about 15 minutes to about 24 hours, and more preferably from about 30 minutes to about 12 hours.

It is also operable to partially cure the curable epoxy resin composition of the present invention to form a B-stage product and subsequently cure the B-stage product completely at a later time.

The curable epoxy resin composition of the present invention may also comprise a curing agent and/or a curing catalyst.

Examples of the curing agent and/or catalyst useful for the curable epoxy resin composition include aliphatic, cycloaliphatic, polycycloaliphatic or aromatic primary monoamines, aliphatic, cycloaliphatic, polycycloaliphatic or aromatic primary and secondary polyamines, carboxylic acids and anhydrides thereof, aromatic hydroxyl containing compounds, imidazoles, guanidines, urea-aldehyde resins, melamine-aldehyde resins, alkoxylated urea-aldehyde resins, alkoxylated melamine-aldehyde resins, amidoamines, epoxy resin adducts, or any combination thereof.

Particularly preferred examples of the curing agent include methylenedianiline, 4,4′-diaminostilbene, 4,4′-diamino-alpha-methylstilbene, 4,4′-diaminobenzanilide, dicyandiamide, ethylenediamine, diethylenetriamine, triethylenetetramine, tetraethylenepentamine, urea-formaldehyde resins, melamine-formaldehyde resins, methylolated urea-formaldehyde resins, methylolated melamine-formaldehyde resins, phenol-formaldehyde novolac resins, cresol-formaldehyde novolac resins, sulfanilamide, diaminodiphenylsulfone, diethyltoluenediamine, t-butyltoluenediamine, bis-4-aminocyclohexylamine, isophoronediamine, diaminocyclohexane, hexamethylenediamine, piperazine, 1-(2-aminoethyl)piperazine, 2,5-dimethyl-2,5-hexanediamine, 1,12-dodecanediamine, tris-3-aminopropylamine, and any combination thereof.

Particularly preferred examples of the curing catalyst include boron trifluoride, boron trifluoride etherate, aluminum chloride, ferric chloride, zinc chloride, silicon tetrachloride, stannic chloride, titanium tetrachloride, antimony trichloride, boron trifluoride monoethanolamine complex, boron trifluoride triethanolamine complex, boron trifluoride piperidine complex, pyridine-borane complex, diethanolamine borate, zinc fluoroborate, metallic acylates such as stannous octoate or zinc octoate, and any combination thereof.

The curing catalyst may be employed in an amount which will effectively cure the curable epoxy resin composition. The amount of the curing catalyst will also depend upon the particular adduct, epoxy resin, and curing agent, if any, employed in the curable epoxy resin composition.

Generally, the curing catalyst may be used in an amount of from about 0.001 to about 2 percent by weight of the total curable epoxy resin composition. In addition, one or more of the curing catalysts may be employed to accelerate or otherwise modify the curing process of the curable epoxy resin composition.

The curing agent may be employed in conjunction with the adduct to cure the curable epoxy resin composition. The amounts of combined curing agent and adduct are from about 0.60:1 to about 1.50:1, and preferably from about 0.95:1 to about 1.05:1 equivalents of reactive hydrogen atom collectively in the curing agent and the adduct.

The curable epoxy resin composition may also be blended with at least one additive including, for example, a cure accelerator, a solvent or diluent, a modifier such as a flow modifier and/or a thickener, a reinforcing agent, a filler, a pigment, a dye, a mold release agent, a wetting agent, a stabilizer, a fire retardant agent, a surfactant, or any combination thereof.

The additive may be blended with the adduct or with the resin compound (D) or with both the adduct and the resin compound (D) prior to use for the preparation of the curable epoxy resin composition of the present invention.

These additives may be added in functionally equivalent amounts, for example, the pigment and/or dye may be added in quantities which will provide the composition with the desired color. In general, the amount of the additives may be from about zero to about 20 percent, preferably from about 0.5 to about 5 percent, and more preferably from about 0.5 to about 3 percent by weight based upon the total weight of the curable epoxy resin composition.

The cure accelerator which can be employed herein includes, for example, mono, di, tri and tetraphenols; chlorinated phenols; aliphatic or cycloaliphatic mono or dicarboxylic acids; aromatic carboxylic acids; hydroxybenzoic acids; halogenated salicylic acids; boric acid; aromatic sulfonic acids; imidazoles; tertiary amines; aminoalcohols; aminopyridines; aminophenols; mercaptophenols; and any mixture thereof.

Particularly suitable cure accelerators include 2,4-dimethylphenol, 2,6-dimethylphenol, 4-methylphenol, 4-tertiary-butylphenol, 2-chlorophenol, 4-chlorophenol, 2,4-dichlorophenol, 4-nitrophenol, 1,2-dihydroxybenzene, 1,3-dihydroxybenzene, 2,2′-dihydroxybiphenyl, 4,4′-isopropylidenediphenol, valeric acid, oxalic acid, benzoic acid, 2,4-dichlorobenzoic acid, 5-chlorosalicylic acid, salicylic acid, p-toluenesulfonic acid, benzenesulfonic acid, hydroxybenzoic acid, 4-ethyl-2-methylimidazole, 1-methylimidazole, triethylamine, tributylamine, N,N-diethylethanolamine, N,N-dimethylbenzylamine, 2,4,6-tris(dimethylamino)phenol, 4-dimethylaminopyridine, 4-aminophenol, 2-aminophenol, 4-mercaptophenol, and any combination thereof.

Examples of the solvent or diluent which can be employed herein include, for example, aliphatic and aromatic hydrocarbons, halogenated aliphatic hydrocarbons, aliphatic ethers, aliphatic nitriles, cyclic ethers, glycol ethers, esters, ketones, amides, sulfoxides, and any combination thereof.

Particularly suitable solvents include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, diethylene glycol methyl ether, dipropylene glycol methyl ether, N-methylpyrrolidinone, N,N-dimethylacetamide, acetonitrile, sulfolane, and any combination thereof.

The modifier such as the thickener and the flow modifier may be employed in amounts of from zero to about 10, preferably, from about 0.5 to about 6, and more preferably from about 0.5 to about 4 percent by weight based upon the total weight of the curable epoxy resin blend composition.

The reinforcing material which may be employed herein includes natural and synthetic fibers in the form of woven fabric, mat, monofilament, multifilament, unidirectional fiber, roving, random fiber or filament, inorganic filler or whisker, or hollow sphere. Other suitable reinforcing material includes glass, carbon, ceramics, nylon, rayon, cotton, aramid, graphite, polyalkylene terephthalates, polyethylene, polypropylene, polyesters, and any combination thereof.

The filler which may be employed herein includes, for example, inorganic oxide, ceramic microsphere, plastic microsphere, glass microsphere, inorganic whisker, calcium carbonate, and any combination thereof.

The filler may be employed in an amount of from about zero to about 95, preferably from about 10 to about 80 percent, and more preferably from about 40 to about 60 percent by weight based upon the total weight of the curable epoxy resin composition.

The adduct of the present invention may be useful as a cycloaliphatic curing agent for producing a cured epoxy resin, including production of fully cycloaliphatic/aliphatic cured epoxy resin (with no aromatic rings).

The adduct may also be employed in, for example, coatings, especially protective coatings with excellent solvent resistant, moisture resistant, abrasion resistant, and weatherable properties. Other applications of the adduct of the present invention may include, for example, preparation of electrical or structural laminate or composite, filament windings, moldings, castings, encapsulation, and the like.

### EXAMPLES

### Abbreviations

The following standard abbreviations are used in the Examples and Comparative Experiments:

GC=gas chromatography (chromatographic)

GPC=gel permeation chromatography (chromatographic)

EEW=epoxide equivalent weight

AHEW=amine hydrogen equivalent weight

RSD=relative standard deviation

DI=deionized

meq=milliequivalent(s)

eq=equivalent(s)

wt=weight(s)

min=minute(s)

hr=hour(s)

g=gram(s)

mL=milliliter(s)

L=liter(s)

LPM=liter(s) per minute

mm=millimeter(s)

M=meter(s)

cp=centipoise

CHDM=cis-, trans- 1,3- and 1,4-cyclohexanedimethanol

CHDM MGE=monoglycidyl ether of 1,3- and 1,4-cyclohexanedimethanol

CHDM DGE=diglycidyl ether of 1,3- and 1,4-cyclohexanedimethanol

EDA=1,2-diaminoethane (ethylenediamine)

DETA=diethylenetriamine (D.E.H.™ 20)

AEP=1-(2-Aminoethyl)piperazine

DGE BPA=diglycidyl ether of bisphenol A

MIBK=methylisobutylketone (4-methyl-2-pentanone)

The CHDM used in the following Examples and Comparative Experiments was a commercial grade product, UNOXOL™ Diol (manufactured and marketed by The Dow Chemical Company). GC analysis of the CHDM revealed the presence of 99.5 area % (22.3, 32.3, 19.6, and 25.3 area % for the 4 individual isomers) with the 0.5 area % balance comprising a single minor impurity.

The DGE BPA used in the following Examples and Comparative Experiments, with the exception of Example 11 Part D, was a commercial grade product, D.E.R.™ 331 (manufactured and marketed by The Dow Chemical Company) comprising 23.38% epoxide (184.02 EEW) by titration and a nominal viscosity averaging 12,500 cp at 25° C. The DGE BPA used in Example 11 Part D was also a commercial grade product (manufactured and marketed by The Dow Chemical Company) but had an EEW of 186.605.

D.E.R., D.E.H. and UNOXOL are trademarks of The Dow Chemical Company.

Analytical Equipment and Methods

The following standard analytical equipment and methods are used in the Examples and Comparative Experiments:

Gas Chromatographic (GC) Analysis

A Hewlett Packard 5890 Series II Plus gas chromatograph was employed using a DB-1 capillary column (61.4 M by 0.25 mm, Agilent). The column was maintained in the chromatograph oven at a 50° C. initial temperature. Both the injector inlet and flame ionization detector were maintained at 300° C. Helium carrier gas flow through the column was maintained at 1.1 mL per min. The temperature program employed a two min hold time at 50° C., a heating rate of 10° C. per min to a final temperature of 300° C., and a hold time at 300° C. of 15 min. When a sample was analyzed with oligomers that did not elute from the column, the chromatograph oven was held at 300° C. prior to analysis of the next sample until the residual oligomers had “burned off”. All components with retention times greater than that of the 4 isomeric CHDM diglycidyl ethers were designated as oligomers in the following Examples and Comparative Experiments. The term “free of oligomeric component(s)” or “substantially free of oligomeric component(s)” used herein means that the oligomer is present at less than 2 percent, preferably less than 1 percent, and more preferably zero percent by weight based on the total weight of the epoxy resin product. All GC analyses in the following Examples and Comparative Experiments are measured in area %, and as such are not a quantitative measure of any given component.

Samples for GC analysis were prepared by collection of a 0.5 mL aliquot of an epoxy resin product from the epoxidation process and addition to a vial comprising 1 mL of acetonitrile. A portion of the product in acetonitrile was mixed then loaded into a 1 mL syringe (Norm-Ject, all polypropylene/polyethylene, Henke Sass Wolf GmbH) and passed through a syringe filter (Acrodisc CR 13 with 0.2 μm PTFE membrane, Pall Corporation, Gelman Laboratories) to remove any inorganic salts or debris.

I.C.I. Cone and Plate Viscosity

Viscosity was determined on an I.C.I. Cone and Plate Viscometer (model VR-4540) at 25° C. The viscometer equipped with a 0-5 poise spindle (model VR-4105) and equilibrated to 25° C. was calibrated to zero. A sample was applied to the viscometer and held for 2 minutes, then the viscosity was checked and the reading was taken after 15 seconds. One or more duplicate viscosity tests were completed using a fresh aliquot of the particular product being tested. The individual measurements were averaged.

Gel Permeation Chromatographic (GPC) Analysis

A PL-gel Mixed E pair of columns maintained at 40° C. were used in series along with a differential refractometer detector (Waters 410). Tetrahydrofuran was used as an eluent at a flow rate of 1 mL per min. The injection volume was 100 microliters. A sample was diluted in tetrahydrofuran to a concentration of 0.45-0.50%. Calibration was performed using Polymer Laboratories Polyethylene Glycol Calibrants, PEG 10, Lot 16. RSD for Mₙ, M_{w}, M_{w}/Mₙ, Mₚ and M_{z} was less than 3% and for M_{z+1} RSD was less than 6%, with the exception of Examples 9 -11 where RSD for Mₙ, M_{w}, M_{w}/Mₙ, Mₚ and M_{z} was less than 4% and for M_{z+1} RSD was less than 8%. The chromatogram was visually examined and different peak windows were selected for individual integration of the respective peaks. Precision was determined by analyzing the sample in duplicate. The RSD's for Mₚ (the molecular weight at the apex of the peak) and area % are less than 1% for peak windows greater than 10% of the total area and less than 10% for peak windows less than 10% of the total area. The area percent and peak molecular weights thus obtained were averaged to give the indicated results in the following Examples and Comparative Experiments.

Hydrolyzable, Ionic and Total Chloride Analysis

Hydrolyzable chloride generally results from a coupling product (e.g. chlorohydrin intermediate) which has not cyclized via dehydrochlorination with sodium hydroxide to give the epoxide ring during the epoxidation process.

Ionic chloride includes sodium chloride co-product from the epoxidation process which has been entrained in the epoxy resin product. Sodium chloride is co-produced in the dehydrochlorination of a chlorohydrin with sodium hydroxide.

Total chloride accounts for the chlorine bound into the epoxy resin structure in the form of a chloromethyl group. The chloromethyl group forms as a result of a coupling reaction of a secondary hydroxyl group in a chlorohydrin intermediate with epi.

The ionic and hydrolyzable and total chlorides were determined using titration methods while the total chloride was determined via X-ray fluorescence analysis.

Percent Epoxide/Epoxide Equivalent Weight (EEW) Analysis

A standard titration method was used to determine percent epoxide in the various epoxy resins. A sample was weighed (ranging from about 0.1-0.2 g) and dissolved in dichloromethane (15 mL). Tetraethylammonium bromide solution in acetic acid (15 mL) was added to the sample. The resultant solution was treated with 3 drops of crystal violet solution (0.1% w/v in acetic acid) and was titrated with 0.1N perchloric acid in acetic acid on a Metrohm 665 Dosimat titrator (Brinkmann). Titration of a blank sample comprising dichloromethane (15 mL) and tetraethylammonium bromide solution in acetic acid (15 mL) provided correction for solvent background. General methods for this titration are found in the scientific literature, for example, Jay, R. R., “Direct Titration of Epoxy Compounds and Aziridines”, Analytical Chemistry, 36, 3, 667-668 (March, 1964).

Differential Scanning Calorimetry (DSC)

A DSC 2910 Modulated DSC (TA Instruments) was employed, using a heating rate of 7° C. per min from 25° C. to 250° C. under a stream of nitrogen flowing at 45 cubic centimeters per min. Specific sample weights are provided in the following Examples and Comparative Experiments.

Preparation of Clear, Unfilled Castings

A mixture of an epoxy resin adduct curing agent and an epoxy resin was placed under a bell jar and all gas bubbles were removed under vacuum before preparing the casting. The degassed mixture was poured into a mold which had been preheated to 50° C., then the degassed mixture was maintained in an oven at 50° C. for the next 16 hr to give a cured product (casting). The mold used comprised two 6 inch by 6 inch aluminum plates. The face of each plate was covered with a 6 inch by 6 inch aluminum sheet coated with a siloxazane polymer. A “U”-shaped ⅛ inch spacer frame and a “U”-shaped interior gasket were positioned between the two aluminum mold release sheets. The gasket was formed from a copper wire encased in silastic rubber tubing. The mold was held together with a series of compression clamps. The casting cured at 50° C. was post cured in the mold using the following procedure: (a) increase the oven temperature setting to 100° C. (requires 16-20 min to achieve 100° C.), (b) hold the oven temperature at 100° C. for 60 min, (c) remove the mold from 100° C. oven and place the mold into an oven maintained at 150° C., (d) hold the oven temperature at 150° C. for 60 min, (e) remove the mold and allow to cool to room temperature, and (f) demold the casting once cooled to room temperature.

Flexural Strength and Modulus Testing

The postcured casting was cut to provide five or six 2.5 inch by 0.5 inch flexural test pieces using a wet saw (Micro-matic Precision Slicing and Dicing Machine, model number WMSA.1015, equipped with a Digital Measuring Display Dynamics Research Corporation, Model 700 12DO). Before testing, the test pieces were held in a constant temperature and humidity room for 40 hr at 73.4° F. +/−3.6° F. and 50% +/−5% relative humidity. Testing was then performed using an Instron 4505 in accordance with ASTM D 790.

The following Examples and Comparative Experiments further illustrate the present invention in detail but are not to be construed to limit the scope thereof.

### EXAMPLE 1

### A. Characterization of CHDM MGE and CHDM DGE with Oligomeric Components

GC analysis of an epoxy resin comprising CHDM MGE and CHDM DGE revealed that the epoxy resin comprised the following: 3.5 area % CHDM MGE (0.9, 0.5, 1.5, and 0.6 area % for the 4 individual isomers), 90.2 area % CHDM DGE (22.2, 33.1, 10.4, and 24.5 area % for the 4 individual isomers), 5.4 area % oligomers (more than 22 minor components), with the balance as several minor impurities. Titration of an aliquot of the epoxy resin demonstrated 30.41% epoxide (141.52 EEW). Viscosity (25° C.) of an aliquot of the epoxy resin averaged 76 cp. Analysis for ionic, hydrolyzable and total chlorides gave the following results: 83 ppm hydrolyzable chloride, 8.156 ppm ionic chloride, 0.2304% total chloride. GPC analysis gave the following results: Mₙ=239, M_{w}=335, M_{w}/Mₙ=1.41, Mₚ=195, M_{z}=708, M_{z+1}=2010. Integration of peak windows of the respective peaks gave the following results:

| Peak Window | Mₚ | Area % |
|---|---|---|
| A | 195 | 71.1 |
| B | 326 | 3.5 |
| C | 446 | 13.8 |
| D | 651 | 4.8 |
| E | 830 | 2.4 |
| F | 1000-6500 MW tail | 4.7 |

### B. Preparation and Characterization of an Adduct of EDA and CHDM MGE and CHDM DGE with Oligomeric Components

A 500 mL 3 neck, glass, round bottom, reactor was charged under nitrogen with EDA (240.34 g, 4.0 moles, 16 amine hydrogen equivalents). The EDA used was a commercial grade product obtained from Aldrich Chemical Company with a purity specification of 99%. The reactor was additionally equipped with a condenser (maintained at −2° C.), a thermometer, a Claisen adaptor, an overhead nitrogen inlet (1 LPM N₂ used), and magnetic stirring. A portion (28.30 g, 0.20 epoxide equivalent) of CHDM MGE and CHDM DGE with oligomeric components from Example 1 Part A above was added to a side arm vented addition funnel, then attached to the reactor. Stirring and heating using a thermostatically controlled heating mantle commenced to give a 75° C. solution. Dropwise addition of the CHDM MGE and CHDM DGE with oligomeric components commenced while maintaining the 75° C. reaction temperature. After 1.9 hr, the dropwise addition was completed. The resultant light yellow colored solution was stirred and maintained at 75° C. for the next 20.0 hr followed by rotary evaporation to remove the bulk of the excess EDA. Additional drying of the solution was completed at 75° C. in the vacuum oven to a constant weight of 40.23 g of a resulting transparent, light amber colored, liquid adduct product. GC analysis of an aliquot of the adduct product revealed that complete reaction of all CHDM MGE and CHDM DGE had occurred.

A portion of EDA reactant was added to acetic acid (25 mL) then titrated using perchloric acid in acetic acid (0.1N). This titration demonstrated 33.5323 meq per g after correction for titration of an acetic acid (25 mL) blank. Since a theoretical 66.5735 meq of NH per g was calculated for EDA, the value of 33.5323 meq per g experimentally obtained was in terms of NH₂ and not NH per g. This information was used to provide a necessary correction factor for the titration of the adduct product.

A portion (0.25 g) of the adduct product was added under nitrogen to acetic anhydride (2.5 mL) then heated to 75° C. for 2 hours. Additional drying was completed at 125° C. in the vacuum oven for 16 hr. The resulting solution was rotary evaporated to remove the excess acetic acid and acetic anhydride, giving a transparent, light amber colored, liquid, acetylated, adduct product. A portion of the acetylated adduct product was added to acetic acid (25 mL) then titrated using perchloric acid in acetic acid (0.1N). This titration demonstrated 0.8114 meq per g of tertiary nitrogen present in the adduct after correction for titration of an acetic acid (25 mL) blank (tertiary amine nitrogen in the adduct results from reaction of an epoxide group with a primary amine hydrogen followed by a second epoxide group reacting with a secondary amine hydrogen attached to the same nitrogen atom). This information was additionally used to provide a necessary correction factor for the following titration of the adduct product.

A second portion of the adduct product was added to acetic acid (25 mL) then titrated using perchloric acid in acetic acid (0.1N). This titration demonstrated a raw value of 10.1744 meq per g. A repeat of the titration demonstrated a raw value of 10.2469 meq per g. Both values are after correction for titration of an acetic acid (25 mL) blank. After correction for NH₂ titrating as NH and correction to remove the tertiary nitrogen, the adduct product was calculated to contain 14.10 meq of NH per g, or an AHEW of 70.92.

### EXAMPLE 2

### Curing of DGE BPA with EDA Adduct of CHDM MGE and CHDM DGE with Oligomeric Components

A mixture of DGE BPA (2.5955 g, 0.0141 epoxide equivalent) and a portion (1.0003 g, 0.0141 amine hydrogen equivalent) of the EDA adduct of CHDM MGE and CHDM DGE with oligomeric components from Example 1 Part B were vigorously stirred together to give a hazy liquid (slowly separated on standing at room temperature). A DSC analysis was completed using 11.8 mg and 13.1 mg portions of the hazy liquid. An exothermic transition, attributable to reaction of the reactive hydrogen atoms in the adduct with the epoxide groups, was observed with maxima at 90.51° C. and 89.68° C. (average of 90.10° C.) accompanied by enthalpies of 356.2 joules per g and 343.9 joules per g, respectively (average of 350.1 joules per g). The onset temperature for this exothermic transition was 54.7° C. and 53.7° C., respectively (average of 54.2° C.). The remaining portion of the mixture was gently heated, transforming the hazy liquid to a transparent, light yellow colored solution. The curing commenced once this solution state was achieved. The curing was completed at room temperature (at about 25° C.) following by postcuring for one hour in an oven preheated to 150° C. The cured product was a rigid, light yellow colored, transparent solid. A DSC analysis using 33.7 mg and 33.9 mg portions of the cured product gave double glass transition temperatures of 60.21° C. plus 116.11° C. and 65.53° C. plus 113.83° C., respectively (average of 62.87° C. and 114.97° C.).

### EXAMPLE 3

### Curing of CHDM MGE and CHDM DGE with Oligomeric Components and EDA Adduct of CHDM MGE and CHDM DGE with Oligomeric Components

A portion (1.7792 g, 0.0126 epoxide equivalent) of the mixture of CHDM MGE and CHDM DGE with oligomeric components from Example 1 Part A and a portion (0.8916 g, 0.0126 amine hydrogen equivalent) of the EDA adduct of CHDM MGE and CHDM DGE with oligomeric components from Example 1 Part B were vigorously stirred together to give a hazy mixture (slowly separated on standing at room temperature). DSC analysis was completed using 11.0 mg and 10.4 mg portions of the hazy mixture. An exothermic transition, attributable to reaction of active hydrogen groups in the adduct with the epoxide groups was observed with maxima at 106.68° C. and 106.83° C. (average of 106.76° C.) accompanied by enthalpies of 250.4 joules per g and 295.6 joules per g, respectively (average of 273.0 joules per g). The onset temperature for this exothermic transition was 61.3° C. and 60.9° C., respectively (average of 61.1° C.). The remaining portion of the mixture was gently heated, transforming the hazy liquid to a transparent, light yellow colored solution. The curing commenced once this solution state was achieved. The curing was completed at room temperature following by postcuring for one hour in an oven preheated to 150° C. The cured product was a rigid, light yellow colored, transparent solid. DSC analysis completed using 32.5 and 30.4 mg portions of the cured product gave glass transition temperatures of 56.93° C. and 57.17° C., respectively (average of 57.05° C.).

### Comparative Experiment A

### A. Characterization of Commercial Grade Diglycidyl Ether of cis, trans-1,4-Cyclohexanedimethanol

A commercial grade of “technical grade” diglycidyl ether of cis,trans-1,4-cyclohexanedimethanol obtained from Aldrich Chemical Company (batch #22009TC) was analyzed by GC revealing 1.6 area % cis,trans-1,4-cyclohexanedimethanol (0.3 and 1.3 area % for the 2 individual isomers), 7.8 area % cis,trans-1,4-cyclohexanedimethanol monoglycidyl ether (4.7 and 3.1 area % for the 2 individual isomers), 61.2 area % cis,trans-1,4-cyclohexanedimethanol diglycidyl ether (19.1 and 42.1 area % for the 2 individual isomers), 29.2 area % oligomers (0.63, 1.35, 1.44, 0.68, 7.20, 17.30, 0.22, 0.21, and 0.20 area % for the 9 individual components), with the 0.2 area % balance as a single unknown component. GC analysis furnished with the product by Aldrich Chemical reported a 56.7% mixture of cis and trans-1,4-isomers. Titration of an aliquot of the product demonstrated 27.05% epoxide (159.05 EEW). The EEW furnished with the product by Aldrich Chemical was 159. Viscosity of an aliquot of the product at 25° C. was determined on an I.C.I. Cone and Plate Viscometer. Viscosity (25° C.) of an aliquot of the epoxy resin averaged 69 cp. The viscosity furnished with the product by Aldrich Chemical was 71 cp at 25° C. Analysis for ionic, hydrolyzable and total chlorides gave the following results: hydrolyzable Cl=536 ppm, ionic Cl=21.60 ppm, total Cl=2.356%. GPC analysis gave the following results: Mₙ=245, M_{w}=265, M_{w}/Mₙ=1.08, Mₚ=205, M_{z}=292, M_{z+1}=331. Integration of peak windows of the respective peaks gave the following results:

| Peak Window | Mₚ | Area % |
|---|---|---|
| A | 205 | 56.1 |
| B | 308 | 33.9 |
| C | 401 | 8.5 |
| D | 400-1000 MW tail | 2.0 |

### B. Preparation and Characterization of an Adduct of EDA and Mono and Diglycidyl Ethers of cis, trans-1,4-Cyclohexanedimethanol with Oligomeric Components

A 500 mL, 3 neck, glass, round bottom, reactor was charged under nitrogen with EDA (240.34 g, 4.0 moles, 16 amine hydrogen equivalents). The EDA used is described in Example 1 Part A. The reactor was additionally equipped with a condenser (maintained at −2° C.), a thermometer, a Claisen adaptor, an overhead nitrogen inlet (1 LPM N₂ used), and magnetic stirring. A portion (31.81 g, 0.20 epoxide equivalent) of mono and diglycidyl ethers of cis, trans-1,4-cyclohexanedimethanol with oligomeric components from Comparative Experiment Part A above was added to a side arm vented addition funnel, then attached to the reactor. Stirring and heating using a thermostatically controlled heating mantle commenced to give a 75° C. solution. Dropwise addition of the mono and diglycidyl ethers of cis, trans-1,4-cyclohexanedimethanol with oligomeric components commenced while maintaining the 75° C. reaction temperature. After 1.9 hr, the dropwise addition was completed. The resulting light yellow colored solution was stirred and maintained at 75° C. for the next 22.3 hr followed by rotary evaporation to remove the bulk of the excess EDA. Additional drying of the solution was completed at 75° C. in the vacuum oven to a constant weight of 47.27 g of transparent, light amber colored, liquid adduct product. GC analysis of an aliquot of the adduct product revealed that complete reaction of all mono and diglycidyl ethers had occurred.

A portion of the adduct product was acetylated and the resultant acetylated adduct was titrated using the method of Example 1 Part B. This titration demonstrated 0.8257 meq per g of tertiary nitrogen present in the adduct. This information was used to provide a necessary correction factor for the following titration of the adduct product. A second portion of the adduct product was titrated using the method of Example 1 Part B. This titration demonstrated a raw value of 10.0192 meq per g. After correction for NH₂ titrating as NH (obtained in Example 1 Part B) and correction to remove the tertiary nitrogen, the adduct product was calculated to contain 13.79 meq of NH per g, or an AHEW of 72.52.

### Comparative Experiment B

### Curing of DGE BPA with EDA Adduct of Mono and Diglycidyl ethers of cis, trans-1,4-Cyclohexanedimethanol with Oligomeric Components

DGE BPA (2.5593 g, 0.0139 epoxide equivalent) and a portion (1.0086 g, 0.0139 amine hydrogen equivalent) of the EDA adduct of mono and diglycidyl ethers of cis, trans-1,4-cyclohexanedimethanol with oligomeric components from Comparative Experiment A Part B were vigorously stirred together to give a hazy mixture which immediately phase separated when stirring ceased. DSC analysis was completed using 9.8 mg and 10.9 mg portions of the freshly stirred hazy mixture. An exothermic transition, attributable to reaction of active hydrogen groups with the epoxide groups was observed with maxima at 98.3° C. and 98.9° C. (average of 98.6° C.) accompanied by enthalpies of 242.8 joules per g and 212.0 joules per g, respectively (average of 227.4 joules per g). The onset temperature for this exothermic transition was 67.7° C. and 69.3° C., respectively (average of 68.5° C.). In both of the DSC analyses the exothermic peak possessed a substantial leading edge shoulder (comprised approximately 25% of the peak area). The remaining portion of the mixture was gently heated, transforming the hazy liquid to a transparent, light yellow colored solution. The curing commenced once this solution state was achieved. The curing was completed at room temperature following by postcuring for one hour in an oven preheated to 150° C. The cured product was a rigid, yellow colored, transparent solid. DSC completed using 30.2 mg and 30.8 mg portions of the cured product gave either triple or double glass transition temperatures of 34.99° C. plus 51.52° C. plus 113.84° C. and 37.47° C. plus 93.26° C., respectively.

### Comparative Experiment C

### Curing of Mono and Diglycidyl Ethers of cis, trans-1,4-Cyclohexanedimethanol with Oligomeric Components with the EDA Adduct of Mono and Diglycidyl Ethers of cis, trans-1,4-Cyclohexanedimethanol with Oligomeric Components

A portion (2.2022 g, 0.0139 epoxide equivalent) of the mono and diglycidyl ethers of cis, trans-1,4-cyclohexanedimethanol with oligomeric components from Comparative Experiment A Part A and a portion (1.0041 g, 0.0139 amine hydrogen equivalent) of the EDA adduct of mono and diglycidyl ethers of cis, trans-1,4-cyclohexanedimethanol with oligomeric components from Comparative Experiment A Part B were vigorously stirred together but would not mix. When gently heated to the temperature required to get both components into solution as a yellow colored liquid, an uncontrolled curing commenced once this solution state was achieved. The uncontrolled curing involved a large exothermic releasing of energy in a short time period which resulted in a yellow colored product with black char in the center. The aforementioned results were reproduced in a second attempt.

### EXAMPLE 4

### Preparation and Characterization of a Clear, Unfilled Casting Using CHDM MGE and CHDM DGE with Oligomeric Components and the EDA Adduct of CHDM MGE and CHDM DGE with Oligomeric Components

A portion (25.00 g, 0.1767 epoxide equivalent) of the CHDM MGE and CHDM DGE with oligomeric components from Example 1 Part A above which had been preheated to 50° C. and a portion (12.53 g, 0.1767 amine hydrogen equivalent) of the EDA adduct of CHDM MGE and CHDM DGE with oligomeric components from Example 1 Part B which had been preheated to 50° C. were vigorously stirred together to give a slightly hazy solution which was used to prepare a clear, unfilled casting according to the procedure described above for the preparation of clear, unfilled castings. The postcured, visually homogeneous, transparent, light amber colored casting gave a flexural strength of 9096 psi +/−146 psi and a flexural modulus of 331,990 psi +/−6735 psi. DSC analysis completed using 28.0 mg and 27.4 mg portions of the cured casting gave glass transition temperatures of 51.34° C. and 51.43° C., respectively (average of 51.39° C.), with no residual cure energy observed.

### Comparative Experiment D

### Attempted Preparation of a Clear, Unfilled Casting Using Mono and Diglycidyl ethers of cis, trans-1,4-Cyclohexanedimethanol with Oligomeric Components and the EDA Adduct of Mono and Diglycidyl ethers of cis, trans-1,4-Cyclohexanedimethanol with Oligomeric Components

A portion (27.00 g, 0.1698 epoxide equivalent) of the mono and diglycidyl ethers of cis, trans-1,4-cyclohexanedimethanol with oligomeric components from Comparative Experiment A Part A which had been preheated to 50° C. and a portion (12.31 g, 0.1698 amine hydrogen equivalent) of the EDA adduct of mono and diglycidyl ethers of cis, trans-1,4-cyclohexanedimethanol with oligomeric components from Comparative Experiment A Part B which had been preheated to 50° C. were vigorously stirred together. The inhomogeneous mixture was degas sed and poured into a mold to prepare a clear, unfilled casting according to the procedure described in the Preparation of Clear, Unfilled Castings above. However, the mixture was not cured in the mold. When the mold was disassembled after completion of the post curing cycle, the product in the mold was half liquid and half gelatinous solid.

### EXAMPLE 5

### A. Characterization of CHDM MGE and CHDM DGE with Oligomeric Components

GC analysis of an epoxy resin revealed 3.4 area % CHDM MGE (1.02, 0.60, 1.12, and 0.66 area %), 93.62 area % CHDM DGE (24.16, 33.49, 10.52, and 25.45 area %), 2.1 area % oligomers (more than 25 minor components), with the balance as several minor impurities. Titration of an aliquot of the epoxy resin demonstrated 30.37% epoxide (141.71 EEW). Viscosity (25° C.) of an aliquot of the epoxy resin averaged 86 cp. Analysis for ionic, hydrolyzable and total chlorides gave the following results: 112 ppm hydrolyzable chloride, 13.9 ppm ionic chloride and 0.146% total chloride. GPC analysis gave the following results: Mₙ=247, M_{w}=364, M_{w}/Mₙ=1.47, Mₚ=197, M_{z}=754, M_{z+1}=1602. Integration of peak windows of the respective peaks gave the following results:

| Peak Window | Mₚ | Area % |
|---|---|---|
| A | 197 | 68.5 |
| B | 323 | 2.8 |
| C | 447 | 14.5 |
| D | 665 | 5.5 |
| E | 834 | 2.8 |
| F | 1000-6500 MW tail | 6.0 |

### B. Preparation and Characterization of an Adduct of DETA and CHDM MGE and CHDM DGE with Oligomeric Components

A 500 mL, 3 neck, glass, round bottom, reactor was charged under nitrogen with DETA (309.43 g, 3.0 moles, 15 amine hydrogen equivalents). The DETA used was a commercial grade product obtained from The Dow Chemical Company (D.E.H.™ 20). The reactor was additionally equipped with a condenser (maintained at −2° C.), a thermometer, a Claisen adaptor, an overhead nitrogen inlet (1 LPM N₂ used), and magnetic stirring. A portion (21.26 g, 0.15 epoxide equivalent) of the CHDM MGE and CHDM DGE with oligomeric components from Example 5 Part A above was added to a side arm vented addition funnel, then attached to the reactor. Stirring and heating using a thermostatically controlled heating mantle commenced to give a 40° C. solution. Dropwise addition of the CHDM MGE and CHDM DGE with oligomeric components commenced while maintaining the 40° C. reaction temperature. After 1.3 hr, the dropwise addition was completed. The stirred, light yellow colored solution was maintained at 40° C. for the next 21.5 hr followed by rotary evaporation to remove the bulk of the excess DETA. Additional drying was completed at 125° C. in the vacuum oven to a constant weight of 36.07 g of transparent, light yellow colored, liquid adduct product. GC analysis of an aliquot of the adduct product revealed that complete reaction of all mono and diglycidyl ethers had occurred. Titration of the adduct product using the method of Example 1 Part B demonstrated an average AHEW of 70.79.

### EXAMPLE 6

### Preparation of a Clear, Unfilled Casting Using CHDM MGE and CHDM DGE with Oligomeric Components and the DETA Adduct of CHDM MGE and CHDM DGE with Oligomeric Components

A portion (25.40 g, 0.1792 epoxide equivalent) of CHDM MGE and CHDM DGE with oligomeric components from Example 5 Part A which had been preheated to 50° C. and a portion (12.69 g, 0.1792 amine hydrogen equivalent) of the DETA adduct of CHDM MGE and CHDM DGE with oligomeric components from Example 5 Part B which had been preheated to 50° C. were vigorously stirred together to give a slightly hazy solution which was used to prepare a clear, unfilled casting according to the procedure described in the Preparation of Clear, Unfilled Castings above. The postcured, visually homogeneous, transparent, light amber colored casting gave a flexural strength of 9192 psi +/−146 psi and a flexural modulus of 290,427 psi +/−6213 psi. DSC analysis completed using 28.5 mg and 31.7 mg portions of the cured casting gave glass transition temperatures of 62.48° C. and 62.11° C., respectively (average of 62.30° C.), with no residual cure energy observed.

### EXAMPLE 7

### Preparation and Characterization of an Adduct of AEP and CHDM MGE and CHDM DGE with Oligomeric Components

A 500 mL, 3 neck, glass, round bottom, reactor was charged under nitrogen with AEP (387.6 g, 3.0 moles, 9 amine hydrogen equivalents). The AEP used was a commercial grade product obtained from Aldrich Chemical Company with a purity specification of 99%. The reactor was additionally equipped with a condenser (maintained at −2° C.), a thermometer, a Claisen adaptor, an overhead nitrogen inlet (1 LPM N₂ used), and magnetic stirring. A portion (21.26 g, 0.15 epoxide equivalent) of CHDM MGE and CHDM DGE with oligomeric components from Example 5 Part A was added to a side arm vented addition funnel, then attached to the reactor. Stirring and heating using a thermostatically controlled heating mantle commenced to give a 40° C. solution. Dropwise addition of the CHDM MGE and CHDM DGE with oligomeric components commenced while maintaining the 40° C. reaction temperature. After 0.6 hr, the dropwise addition was completed. The stirred, yellow colored solution was maintained at 40° C. for the next 23.3 hr followed by rotary evaporation to remove the bulk of the excess AEP. Additional drying was completed at 125° C. in the vacuum oven to a constant weight of 40.97 g of transparent, light amber colored, liquid adduct product. GC analysis of an aliquot of the adduct product revealed that complete reaction of all CHDM MGE and CHDM DGE has occurred. Titration of the adduct product using the method of Example 1 Part B demonstrated an average AHEW of 157.51.

### EXAMPLE 8

### Preparation of a Clear, Unfilled Casting Using CHDM MGE and CHDM DGE with Oligomeric Components with the AEP Adduct of CHDM MGE and CHDM DGE with Oligomeric Components

A portion (15.7372 g, 0.1111 epoxide equivalent) of CHDM MGE and CHDM DGE with oligomeric components from Example 5 Part A which had been preheated to 50° C. and a portion (17.4919 g, 0.1111 amine hydrogen equivalent) of the AEP adduct of CHDM MGE and CHDM DGE with oligomeric components from Example 7 which had been preheated to 50° C. were vigorously stirred together to give a transparent solution which was used to prepare a clear, unfilled casting according to the procedure described above for the preparation of clear, unfilled castings. The postcured, visually homogeneous, transparent, light amber colored casting gave a flexural strength of 7551 psi +/−110 psi and a flexural modulus of 238,685 psi +/−5274 psi. DSC analysis completed using 27.4 mg and 29.5 mg portions of the cured casting gave glass transition temperatures of 49.74° C. and 50.41° C., respectively (average of 50.08° C.), with no residual cure energy observed.

### EXAMPLE 9

### A. Characterization of High Purity CHDM DGE (Free of Oligomeric Components)

GC analysis of a distilled epoxy resin revealed 2.00 area % CHDM MGE, 96.35 area % CHDM DGE (25.61, 36.71, 11.30, and 22.73 area %), with the balance as 4 minor impurities. Titration of an aliquot of the epoxy resin demonstrated 30.81% epoxide (139.66 EEW).

### B. Preparation and Characterization of an Adduct of DETA and High Purity CHDM DGE

A 5 L, 3 neck, glass, round bottom, reactor was charged under nitrogen with DETA (3341.4 g, 32.39 moles, 161.94 amine hydrogen equivalents). The reactor was additionally equipped with a condenser (maintained at 0° C.), a thermometer, a Claisen adaptor, an overhead nitrogen inlet (1 LPM N₂ used), and a stirrer assembly (teflon paddle, glass shaft, variable speed motor). A portion (220.6 g, 1.6194 epoxide equivalent) of CHDM DGE free of oligomeric components from Example 9 Part A above was added to a side arm vented addition funnel, then attached to the reactor. Stirring and heating using a thermostatically controlled heating mantle commenced to give a 40° C. solution. Dropwise addition of the CHDM DGE commenced while maintaining the 40° C. reaction temperature. After 8.2 hr, the dropwise addition was completed. The stirred, light yellow colored solution was maintained at 40° C. for the next 48 hr followed by rotary evaporation to remove the bulk of the excess DETA. Finishing the rotary evaporation at 140° C. for 2 hours provided the adduct product (386.2 g) as a light yellow colored viscous liquid. GC analysis of an aliquot of the adduct product revealed that complete reaction of the diglycidyl ether (and the minor amount of monoglycidyl ether) had occurred. Titration of the adduct product using the method of Example 1 Part B demonstrated an average AHEW of 65.22.

### EXAMPLE 10

### A. Characterization of High Purity CHDM DGE (Free of Oligomeric Components)

GC analysis of a distilled epoxy resin revealed 1.54 area % CHDM MGE, 96.55 area % CHDM DGE (28.28, 33.54, 11.12, and 23.61 area % for the 4 individual isomers), with the balance as 6 minor impurities. Titration of an aliquot of the epoxy resin demonstrated 31.58% epoxide (136.24 EEW).

### B. Preparation and Characterization of an Adduct of n-Butylamine and High Purity CHDM DGE

A 2 L, 3 neck, glass, round bottom, reactor was charged under nitrogen with n-butylamine (914.25 g, 12.5 moles, 25 amine hydrogen equivalents). The n-butylamine used was a commercial grade product obtained from Aldrich Chemical Company with a purity specification of 99.5%. The reactor was additionally equipped with a condenser (maintained at 0° C.), a thermometer, a Claisen adaptor, an overhead nitrogen inlet (1 LPM N₂ used), and a stirrer assembly (teflon paddle, glass shaft, variable speed motor). A portion (68.12 g, 0.50 epoxide equivalent) of the CHDM DGE free of oligomeric components from Example 10 Part A above was added to a side arm vented addition funnel, then attached to the reactor. Stirring and heating using a thermostatically controlled heating mantle commenced to give a 40° C. solution. Dropwise addition of the CHDM DGE commenced while maintaining the 40° C. reaction temperature. After 15.6 hr, the dropwise addition was completed. The stirred, light yellow colored solution was maintained at 40° C. for the next 24.4 hr followed by rotary evaporation to remove the bulk of the excess n-butylamine. Finishing the rotary evaporation at 110° C. for 2 hours provided the adduct product (104.08 g) as a light yellow colored liquid. GC analysis of an aliquot of the adduct product revealed that complete reaction of the diglycidyl ether (and the minor amount of monoglycidyl ether) had occurred. Titration of the adduct product using the method of Example 1 Part B demonstrated an average AHEW of 224.79.

### EXAMPLE 11

### A. Characterization of CHDM MGE and CHDM DGE with Oligomeric Components from Lewis Acid Catalyzed Coupling and Epoxidation Process

GC analysis of a CHDM MGE and CHDM DGE with oligomeric components from a Lewis acid catalyzed coupling and epoxidation process revealed 0.12 area % CHDM, 7.88 area % CHDM MGE (2.91, 1.41, 2.61, and 0.95 area % for the 4 individual isomers), 50.48 area % CHDM DGE (10.07, 18.16, 5.35, and 16.90 area % for the 4 individual isomers), 40.60 area % oligomers, with the balance as minor impurities. Titration of an aliquot of the epoxy resin demonstrated 25.71% epoxide (167.39 EEW).

### B. Preparation and Characterization of an Adduct of Ammonia and CHDM MGE and CHDM DGE With Oligomeric Components from Lewis Acid Catalyzed Coupling and Epoxidation Process

A 5 L, 3 neck, glass, round bottom, reactor was charged under nitrogen with ammonium hydroxide (1474.6 g, moles, approximately 75 amine hydrogen equivalents) and isopropanol (1474.6 grams). The ammonium hydroxide used was a commercial grade product obtained from Aldrich Chemical Company with a purity specification of 28 to 30 as % NH₃. The reactor was additionally equipped with a condenser (maintained at 0° C.), a thermometer, a Claisen adaptor, and a stirrer assembly (teflon paddle, glass shaft, variable speed motor) (note: the reaction was run under air, not under nitrogen). A portion (167.39 g, 1.00 epoxide equivalent) of CHDM MGE and CHDM DGE with oligomeric components from Example 11 Part A was added to a side arm vented addition funnel, then attached to the reactor. Stirring and heating using a thermostatically controlled heating mantle commenced to give a 35° C. solution. Dropwise addition of the CHDM MGE and CHDM DGE with oligomeric components commenced while maintaining the 35° C. reaction temperature. After 16.3 hr, the dropwise addition was completed. The stirred, colorless, transparent solution was maintained at 35° C. for the next 48 hr followed by filtration through a medium fritted glass funnel then rotary evaporation to remove the bulk of the excess ammonium hydroxide. Finishing the rotary evaporation at 110° C. and 1.9 mm Hg for 2 hours provided the adduct product (180.76 g) as a transparent, colorless liquid. GC analysis of an aliquot of the adduct product revealed that complete reaction of the diglycidyl ether (and the minor amount of monoglycidyl ether) had occurred.

### C. Preparation of Blend of DETA with Ammonia Adduct

While still warm from the rotary evaporation, the ammonia adduct from Example 11 Part B above was combined with DETA (61.33 g, 25.33% wt. of the total blend) and shaken to give a homogeneous, transparent, pale yellow colored liquid blend after cooling to room temperature. Titration of the blend using the method of Example 1 Part B demonstrated an average AHEW of 52.38.

### D. Curing of DGE BPA with the Blend of DETA with Ammonia Adduct

DGE BPA (3.7614 grams, 0.02016 epoxide equivalent) and a portion (1.0558 g, 0.02016 amine hydrogen equivalents) of the blend of DETA and ammonia adduct from Example 11 Part C above were mixed together in an aluminum pan and allowed to cure at room temperature. Postcuring was completed at 100° C. for 2 hr, 150° C. for 2 hr, and 200° C. for 2 hr to give a rigid, transparent, amber colored casting. DSC analysis completed using 32.3 and 33.4 mg portions of the casting gave glass transition temperatures of 100.3 and 100.9° C. (average of 100.6° C.). A slight exothermic shift was observed beginning at 181.21 and 179.78° C. (average of 180.50° C.).

It will be obvious to persons skilled in the art that certain changes may be made in the methods described above without departing from the scope of the invention. It is therefore intended that all matter herein disclosed be interpreted as illustrative only and not as limiting the scope of protection sought. Moreover, the process of the present invention is not to be limited by the specific examples set forth above including the tables to which they refer. Rather, these examples and the tables they refer to are illustrative of the process of the invention.

1. An adduct comprising at least one reaction product of (i) an epoxy resin material (A) and (ii) a reactive compound (B); wherein the epoxy resin material (A) comprises a cis, trans-1,3- and -1,4-cyclohexanedimethylether moiety; and wherein the reactive compound (B) comprises a compound having two or more reactive hydrogen atoms per molecule, and the reactive hydrogen atoms are reactive with epoxide groups.

2. The adduct according to claim 1, (i) wherein the epoxy resin material (A) comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol; (ii) wherein the epoxy resin material (A) comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, and one or more oligomers thereof; (iii) wherein the epoxy resin material (A) comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, and a monoglycidyl ether of trans-1,4-cyclohexanedimethanol; or wherein the epoxy resin material (A) comprises a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, a monoglycidyl ether of trans-1,4-cyclohexanedimethanol, and one or more oligomers thereof.

3. The adduct according to claim 2, wherein the epoxy resin material (A) comprises a controlled amount of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol; and wherein the epoxy resin material (A) comprises from about 0.1 percent to about 90 percent by weight of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol based on the total weight of the epoxy resin material (A).

4. The adduct according to claim 1, wherein the reactive compound (B) comprises at least one of (a) a di- or a polyphenol, (b) a di- or a polycarboxylic acid, (c) a di- or a polymercaptan, (d) a di- or a polyamine, (e) a primary monoamine, (f) a sulfonamide, (g) an aminophenol, (h) an aminocarboxylic acid, (i) a phenolic hydroxyl containing carboxylic acid, (j) a sulfanilamide, and (k) any combination thereof.

5. The adduct according to claim 1, wherein reactive compound (B) comprises ammonia; and wherein the ammonia is liquified ammonia (NH₃) or ammonium hydroxide (NH₄OH); and wherein the ratio of reactive compound (B) to the epoxy resin material (A) is from about 2:1 to about 100:1 equivalents of the reactive hydrogen atoms in the reactive compound (B) per equivalent of epoxide group in the epoxy resin material (A).

6. The adduct according to claim 1, wherein the adduct comprises an oligomeric structure; or wherein the adduct comprises a branched or crosslinked oligomeric structure.

7. The adduct according to claim 1, including wherein the resin compound (C) comprises one or more epoxy resins other than the epoxy resin material (A).

8. A process for preparing an adduct comprising the step of reacting (i) at least one of an epoxy resin material (A) and (ii) a reactive compound (B); wherein the epoxy resin material (A) comprises a cis, trans-1,3- and -1,4-cyclohexanedimethylether moiety, and where the reactive compound (B) comprises a compound having two or more reactive hydrogen atoms per molecule, and the reactive hydrogen atoms are reactive with epoxide groups.

9. The process according to claim 8, wherein the epoxy resin material (A) is (i) directly mixed together with reactive compound (B); (ii) added to reactive compound (B) in incremental steps; or (iii) added to reactive compound (B) continuously.

10. The process according to claim 8, wherein the epoxy resin material (A) further comprises at least one solvent; and/or wherein reactive compound (B) further comprises at least one solvent.

11. A curable epoxy resin composition comprising (a) an adduct and (b) a resin compound (D); wherein the adduct comprises (i) at least one reaction product of an epoxy resin material (A) and (ii) a reactive compound (B), wherein the epoxy resin material (A) comprises a cis, trans-1,3- and -1,4-cyclohexanedimethylether moiety; and wherein the reactive compound (B) comprises a compound having two or more reactive hydrogen atoms per molecule and the reactive hydrogen atoms are reactive with epoxide groups; and wherein the resin compound (D) comprises one or more epoxy resins other than the epoxy resin material (A).

12. The composition according to claim 11, wherein the reactive compound (B) in the adduct comprises an aliphatic or cycloaliphatic diamine, an aliphatic or cycloaliphatic polyamine, an aliphatic or cycloaliphatic dicarboxylic acid, an aliphatic or cycloaliphatic aminocarboxylic acid, a diaminocarboxylic acid, an aminodicarboxylic acid, a diaminodicarboxylic acid, or any combination thereof; and wherein the ratio of the adduct and the resin compound (D) is from about 0.60:1 to about 1.50:1 equivalents of reactive hydrogen atom in the adduct per equivalent of epoxide group in the resin compound (D).

13. The composition according to claim 11 further comprising a curing agent and/or a curing catalyst; and/or wherein the adduct comprises a linear chain extender.

14. The composition according to claim 13, wherein the linear chain extender is a reaction product of the (i) epoxy resin material (A) and (ii) reactive compound (B); wherein the epoxy resin material (A) comprises diglycidyl ethers of cis and trans -1,3- and 1,4-cyclohexanedimethanol; and wherein the reactive compound (B) comprises a primary monoamine or a secondary diamine.

15. A process comprising the step of curing the curable epoxy resin composition of claim 12.

16. The process according to claim 15, wherein the process comprises partially curing the curable epoxy resin composition to form a B-stage product and subsequently curing the B-stage product completely at a later time.

17. A cured epoxy resin prepared by the process according to claim 15.

18. An article comprising the cured epoxy resin according to claim 17; and wherein the article is at least one of a coating; an electrical or structural laminate; an electrical or structural composite; a filament winding; a molding; a casting; and an encapsulation.
